(19) United States
(12) Patent Application Publication
(10) Pub. No.: US 2016/0381694 A1
(43) Pub. Date: Dec. 29, 2016

(54) WIRELESS COMMUNICATION SYSTEM, TERMINAL, AND PROCESSING METHOD

(71) Applicant: FUJITSU LIMITED, Kawasaki-shi (JP)

(72) Inventors: Tetsuya YANO, Yokohama (JP); Michiharu Nakamura, Yokosuka (JP); YOSHINORI TANAKA, Yokohama (JP); Kotaro Shiizaki, Kawasaki (JP); Daisuke JITSUKAWA, Adachi (JP); Hongyang CHEN, Kawasaki (JP); Yoshiaki Ohta, Yokohama (JP); KENJI SUDA, Yokohama (JP)

(73) Assignee: FUJITSU LIMITED, Kawasaki-shi (JP)

(21) Appl. No.: 15/259,774

(22) Filed: Sep. 8, 2016

Related U.S. Application Data
(63) Continuation of application No. PCT/JP2014/066801, filed on Jun. 25, 2014.

(30) Foreign Application Priority Data
Mar. 18, 2014 (WO) JP2014/057317

(51) Int. Cl. H04W 72/10

(52) U.S. Cl. CPC H04W 72/10

(57) ABSTRACT

A wireless system includes a plurality of terminals and a wireless base station. Each of the plurality of terminals determines a priority of a local terminal related to transmission of a certain signal according to a certain rule when the certain signal is not received from the wireless base station.

### CROSS-REFERENCE TO RELATED APPLICATION

This application is a continuation application of International Application PCT/JP2014/066801, filed on Jun. 25, 2014 and designated the U.S., which is based upon and claims the benefit of priority of the prior International Application PCT/JP2014/057317, filed on Mar. 18, 2014. The entire contents of these applications are incorporated herein by reference.

### TECHNICAL FIELD

The present invention relates to a wireless communication system, a terminal, and a processing method.

### BACKGROUND ART

In recent years, a next-generation wireless communication technique of providing further sophistication, a larger capacity and a higher functionality of wireless communication in wireless communication systems such as a mobile telephone system (cellular system) and the like has been studied.

For example, 3GPP (3rd Generation Partnership Project) studies D2D (Device to Device) communication for realizing direct communication between a plurality of terminals without wireless base stations.

The D2D communication is assumed to be executed for public safety, for instance. For example, when each wireless base station stops functioning due to a disaster such as an earthquake or a fire, it is possible to transmit useful information for saving lives of people between terminals by executing the D2D communication.

Further, for example, the D2D communication is assumed to be executed to disperse a communication traffic in a wireless communication system. For example, by executing the D2D communication, it is possible to reduce a load at a higher level side than each wireless base station in the wireless communication system.

Further, wireless communication systems which each include a plurality of terminals and in which terminals directly communicate with each other are known (see, for example, Patent Literatures 1 to 11 and Non Patent Literature 1).

In the wireless communication systems disclosed in Patent Literatures 1 to 11 and Non Patent Literature 1, a plurality of neighboring terminals forms clusters (also referred to as groups). In each cluster, one terminal serves as a cluster head (also referred to as a group owner) and other terminals are cluster members. Each cluster member performs communication via the cluster head.

Further, in the wireless communication systems disclosed in Patent Literatures 1 to 11 and Non Patent Literature 1, a parent terminal selects parent terminal candidates from a plurality of child terminals, and notifies the parent terminal candidates of a priority order. Thus, when a broadcast signal is not broadcast for a certain period of time, the parent terminal candidate serves as a new parent terminal in order according to the priority order and transmits broadcast signals.

### CITATION LIST

Patent Literature 1: JP 2008-235961 A
Patent Literature 2: JP 2005-6327 A
Patent Literature 3: JP 2004-282758 A
Patent Literature 4: JP 2012-109827 A
Patent Literature 5: JP 2010-263349 A
Patent Literature 6: JP 2010-141726 A
Patent Literature 7: JP 2011-514716 A
Patent Literature 8: JP 2006-311172 A
Patent Literature 9: JP 2010-28636 A
Patent Literature 10: JP 2008-28445 A
Patent Literature 11: JP 2012-156976 A
Non Patent Literature 1: T. Koskela, three others, “Clustering Concept Using Device-To-Device Communication in Cellular System”, Wireless Communications and Networking Conference (WCNC) 2010, IEEE, pp. 1-6, April 2010

### SUMMARY

By the way, it is difficult to effectively utilize radio resources in the wireless communication systems disclosed in Patent Literatures 1 to 11 and Non Patent Literature 1 in some cases.

According to one aspect, a wireless communication system includes a plurality of terminals and a wireless base station. Each of the plurality of terminals determines a priority of a local terminal related to transmission of a certain signal according to a certain rule when the certain signal is not received from the wireless base station (e.g., each of the plurality of terminals fails to receive the certain signal).

According to another aspect, a wireless communication system includes a plurality of terminals and a wireless base station. Each of the plurality of terminals changes a priority according to a state of a local terminal, the priority being related to transmission of a certain signal in place of the wireless base station.

According to another aspect, a wireless communication system includes a plurality of terminals and a wireless base station. A first terminal of the plurality of terminals controls transmission of a certain signal based on a priority of a second terminal of the plurality of terminals in response to reception of the certain signal, the certain signal being transmitted by the second terminal in place of the wireless base station, and the priority of the second terminal being related to the transmission of the certain signal.

According to another aspect, a wireless communication system includes a plurality of terminals and a wireless base station. A first terminal of the plurality of terminals notifies at least one of a second terminal of the plurality of terminals and a third terminal of the plurality of terminals of a timing difference in response to reception of a certain signal from each of the second terminal and the third terminal, while the certain signal is transmitted in place of the wireless base station. The timing difference is a difference between a timing at which the certain signal is received from the second terminal and a timing at which the certain signal is received from the third terminal.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a block diagram illustrating a configuration example of a wireless communication system according to a first embodiment.

FIG. 2 illustrates a block diagram illustrating an example of a configuration of each terminal illustrated in FIG. 1.

FIG. 3 illustrates a block diagram illustrating an example of a function of each terminal illustrated in FIG. 1.

FIG. 4 is a table illustrating an example of priority information stored in each terminal illustrated in FIG. 1.

FIG. 5 is a flowchart illustrating an example of a process executed by each terminal illustrated in FIG. 1 to control transmission of a synchronization signal.

FIG. 6 illustrates an explanatory view illustrating an example of an operation of the wireless communication system illustrated in FIG. 1.

FIG. 7 illustrates a block diagram illustrating an example of a function of each terminal according to Modified Example 1 of the first embodiment.

FIG. 8 is a table illustrating an example of point information stored in each terminal illustrated in FIG. 7.

FIG. 9 illustrates a block diagram illustrating an example of a function of each terminal according to Modified Example 2 of the first embodiment.

FIG. 10 illustrates a block diagram illustrating an example of a function of each terminal according to Modified Example 3 of the first embodiment.

FIG. 11 illustrates a block diagram illustrating an example of a function of each terminal according to a second embodiment.

FIG. 12 is a flowchart illustrating an example of a process executed by each terminal illustrated in FIG. 11 to control transmission of a synchronization signal.

FIG. 13 illustrates a block diagram illustrating an example of a function of each terminal according to Modified Example 1 of the second embodiment.

FIG. 14 is a flowchart illustrating an example of a process executed by each terminal illustrated in FIG. 13 to control transmission of a synchronization signal.

FIG. 15 illustrates a block diagram illustrating an example of a function of each terminal according to Modified Example 2 of the second embodiment.

FIG. 16 is a flowchart illustrating an example of a process executed by each terminal illustrated in FIG. 15 to control transmission of a synchronization signal.

FIG. 17 illustrates a block diagram illustrating an example of a function of each terminal according to a third embodiment.

FIG. 18 is a flowchart illustrating an example of a process executed by each terminal illustrated in FIG. 17 to control transmission of a synchronization signal.

FIG. 19 illustrates explanatory view illustrating an example of an operation of a wireless communication system according to a fourth embodiment.

FIG. 20 illustrates a block diagram illustrating an example of a function of each terminal according to the fourth embodiment.

FIG. 21 is a flowchart illustrating an example of a process executed by each terminal illustrated in FIG. 20 to control transmission of a synchronization signal.

FIG. 22 is a flowchart illustrating an example of a process executed by each terminal illustrated in FIG. 20 to control transmission of a synchronization signal.

FIG. 23 is a flowchart illustrating an example of a process executed by each terminal illustrated in FIG. 20 to control transmission of a synchronization signal.

FIG. 24 illustrates a block diagram illustrating an example of a function of each terminal according to a fifth embodiment.

FIG. 25 is a flowchart illustrating an example of a process executed by each terminal illustrated in FIG. 24 to control transmission of a synchronization signal.

### DESCRIPTION OF EMBODIMENTS

Embodiments of the present invention will be described below with reference to the drawings. However, the embodiments described below are exemplary embodiments. Hence, application of various deformations and techniques which will not be explicitly described below to the embodiments is not excluded. In addition, in the drawings used in the following embodiments, components assigned the same reference numerals will indicate identical or same components unless changes or deformations are not explicitly described.

### First Embodiment

As described above, in wireless communication systems disclosed in Patent Literatures 1 to 11 and Non Patent Literature 1, a parent terminal serving as a cluster head (also referred to as a group owner) gives a notification of a priority order to child terminals serving as cluster members in advance. In this regard, application of techniques disclosed in Patent Literatures 1 to 11 and Non Patent Literature 1 to a wireless communication system in which each terminal performs communication via each wireless base station will be assumed.

In this case, terminals move, and therefore unless each wireless base station determines and sends a notification of a priority order every time a sufficiently short cycle passes, an appropriate terminal fails to be used as a cluster head when, for example, a disaster takes place. Hence, radio resources used to send a notification of the priority order are large.

Further, when each terminal of an idle state moves in the wireless communication system, and even when a wireless base station which is to be a connection destination of this terminal changes, this change is sometimes not notified to the wireless base station. Hence, there is a case where each wireless base station fails to recognize a terminal to be connected to this local wireless base station, which may result in failure of appropriately determination of a priority order.

By the way, when a terminal serving as a cluster head is changed, radio resources are used by each cluster member to change a terminal which is to be a destination of connection. When a priority order fails to be appropriately determined, a terminal serving as a cluster head is frequently changed. Hence, in this case, radio resources used by each cluster member to change a terminal which is to be a destination of connection tend to be large.

Further, when a priority order fails to be appropriately determined, the number of cluster heads tends to be large. As the number of cluster heads is larger, radio resources used to perform communication between cluster heads and control cluster heads, for example, are greater.

Thus, in the above-described wireless communication systems, it is difficult to effectively utilize radio resources in some cases. By contrast with this, radio resources are effectively used in the present embodiment.

A wireless communication system according to the first embodiment will be described in detail below.

(Configuration)

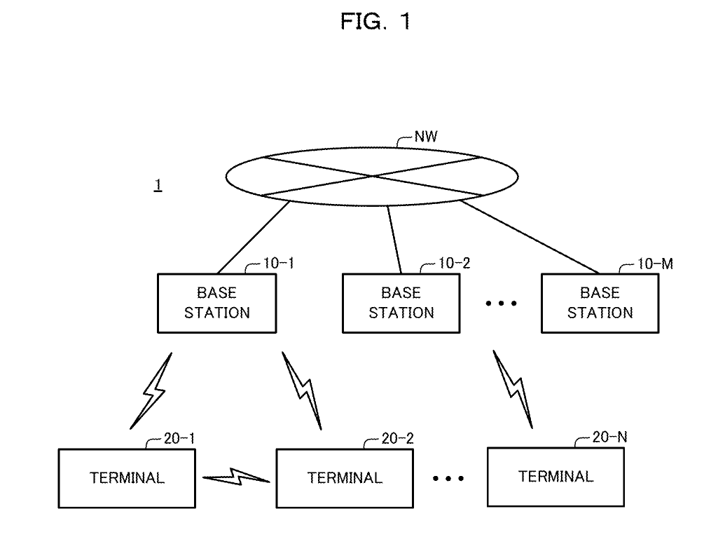

As illustrated in FIG. 1, a wireless communication system 1 according to the first embodiment illustratively includes M base stations 10-1, 10-2, . . . , and 10-M, and N terminals 20-1, 20-2, . . . , and 20-N.

In the present embodiment, the symbol M represents an integer equal to or more than 1. Hereinafter, a base station 10-m will be also referred to as a base station 10 below when distinction is not needing. Here, the symbol m represents an integer from one to M. In the present embodiment, the symbol N represents an integer equal to or more than two. Hereinafter, a terminal 20-n will be also referred to as a terminal 20 below when distinction is not needing. Here, the symbol n represents an integer from one to N.

The wireless communication system 1 performs wireless communication between the base stations 10 and the terminals 20 according to a predetermined wireless communication scheme. For example, the wireless communication scheme is an LTE-Advanced scheme. The LTE is an abbreviation of Long Term Evolution. In addition, the wireless communication scheme may be a scheme (e.g., an LTE or WiMAX (registered trademark) scheme different from the LTE-Advanced scheme. The WiMAX is an abbreviation of Worldwide Interoperability for Microwave Access.

In the present embodiment, each base station 10 forms one wireless area. In addition, each base station 10 may form a plurality of wireless areas. Each wireless area may be referred to as a coverage area or a communication area. For example, a wireless area is a cell such as a macrocell, a microcell, a nanocell, a picocell, a femtocell, a home cell or a sector cell.

Further, each base station 10 may be an eNB (Evolved Node B), a NB (Node B), a macro base station, a micro base station, a nano base station, a pico base station, a femto base station or a home base station. Note that, each base station 10 is an example of a wireless base station.

In the present embodiment, each base station 10 is connected to a communication network (e.g., core network) NW which enables wired communication. In addition, each base station 10 may be connected to the communication network NW which enables wireless communication. An interface between the base station 10 and the communication network NW may be referred to as an S1 interface. Further, an interface between the base stations 10 may be referred to as an X2 interface.

Furthermore, each base station 10 and a portion closer to the communication network (i.e., upper level) NW side than each base station 10 in the wireless communication system 1 may be referred to as E-UTRAN. The E-UTRAN is an abbreviation of Evolved Universal Terrestrial Radio Access Network.

In the present embodiment, each terminal 20 may be referred to as a mobile station, a terminal device or a user terminal (UE; User Equipment). For example, each terminal 20 is a device such as a mobile telephone, a smartphone, a sensor or a meter (measuring equipment). Each terminal 20 may be carried by a user, may be mounted on a moving body such as a vehicle or may be fixed.

Each base station 10 transmits a synchronization signal (SS) in a wireless area. Each terminal 20 detects a synchronization signal in a wireless area including a position of the corresponding each terminal 20 to identify this wireless area, and synchronizes a communication timing with that of the base station 10 which forms this wireless area.

Note that, that it is possible to identify a start time point of a radio frame of a radio signal is an example where communication timings are synchronized. Further, that it is possible to identify a start time point of a symbol of a radio signal is an example where communication timings are synchronized. Furthermore, that communication timings are synchronized between the base station 10 and the terminal 20 in a wireless area formed by the base station 10 is an example where the base station 10 and the terminal 20 are connected.

A synchronization signal is an example of a signal used to detect a wireless area. The synchronization signal may be used to make frequencies used for wireless communication match between the base station 10 and the terminal 20. The synchronization signal is an example of a certain signal.

Each base station 10 allocates radio resources to the terminal 20 with a synchronized communication timing in a wireless area formed by each local base station 10. In the present embodiment, radio resources may include a time and a frequency. In other words, the radio resources may be identified based on the time and the frequency. In a wireless area with a synchronized communication timing, each terminal 20 performs wireless communication with the base station 10 by using radio resources allocated by the base station 10 forming this wireless area.

Further, each terminal 20 performs direct wireless communication with terminals 20 (in other words, other terminals 20) different from the local terminal 20 when a synchronization signal from the base station 10 is not received (e.g., the local terminal 20 fails to receive the synchronization signal). In the present embodiment, part of the terminals 20 among the terminals 20 which do not receive synchronization signals yet from the base station 10 operate as the terminal 20 which backs up at least part of functions of the base station 10. The terminal 20 which backs up at least the part of functions of the base station 10 is also referred to as a cluster head 20 (also referred to as a group owner). The rest of the terminals 20 among the terminals 20 which do not receive synchronization signals yet from the base station 10 will be also referred to as cluster members 20 (also referred to as group members).

In the present embodiment, each cluster head 20 forms a wireless area, and transmits a synchronization signal in the wireless area. Each cluster member 20 detects a synchronization signal in a wireless area including a position of the corresponding each cluster member 20 to identify this wireless area, and synchronize a communication timing with that of the cluster head 20 which forms this wireless area. That communication timings are synchronized between the cluster head 20 and the cluster members 20 in the wireless area formed by the cluster head 20 is an example where the cluster head 20 and the cluster members 20 are connected.

Each cluster head 20 allocates radio resources to the cluster members 20 with the synchronized communication timings in a wireless area formed by each local terminal. In a wireless area with the synchronized communication timing, each cluster member 20 performs wireless communication with the cluster head 20 by using the radio resources allocated by the cluster head 20 forming this wireless area. For example, the cluster members 20 may communicate with the cluster head 20. Further, the cluster members 20 may communicate with other cluster members 20 via the cluster head 20. Furthermore, the cluster members 20 may directly communicate with other cluster members 20 by using radio resources allocated by the cluster head 20.

In the present embodiment, the cluster members 20 communicate with the cluster head 20 or other cluster members 20 by using radio resources allocated by the cluster head 20. By the way, the cluster members 20 may select radio resources to be used by the each local cluster member 20 among predetermined radio resource candidate (also referred to as a resource pool), and communicate with the cluster head 20 or other cluster members 20 by using the selected radio resources. The same applies to other embodiments and Modified Examples, too.

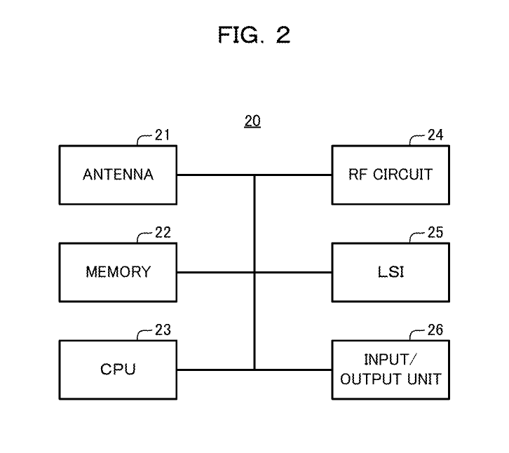

As illustrated in FIG. 2, the terminal 20 illustratively includes an antenna 21, a memory 22, a CPU 23, a RF circuit 24, an LSI 25 and an input/output unit 26. The CPU is an abbreviation of a Central Processing Unit. The RF is an abbreviation of a Radio Frequency. The LSI is an abbreviation of Large Scale Integration.

The memory 22 stores information in a readable and writable way. For example, the memory 22 may be a RAM, a semiconductor memory or an organic memory. The RAM is an abbreviation of a Random Access Memory. The memory 22 may include a ROM. The ROM is an abbreviation of a Read Only Memory.

The CPU 23 executes a program stored in the memory 22 to control the antenna 21, the memory 22, the RF circuit 24, the LSI 25 and the input/output unit 26.

The RF circuit 24 transmits and receives radio signals via the antenna 21. In the present embodiment, transmission and reception of the radio signals include conversion of digital signals and analog signals to and from each other, conversion of a frequency and amplification of the radio signals.

The LSI 25 processes a digital signal for performing wireless communication. The LSI 25 outputs the digital signal based on the radio signal to be transmitted, to the RF circuit 24. The LSI 25 receives an input of the digital signal based on the received radio signal, from the RF circuit 24. In addition, the LSI 25 may include a programmable logic device (PLD).

The input/output unit 26 receives an input of information. For example, this information may be input by a user of the terminal 20. Further, the input/output unit 26 outputs information. In the present embodiment, the input/output unit 26 is a touch panel-type display. In addition, the input/output unit 26 may include a key-type button in addition to a display. Further, the input/output unit 26 may include a display of a different scheme from a touch panel-type.

(Function)

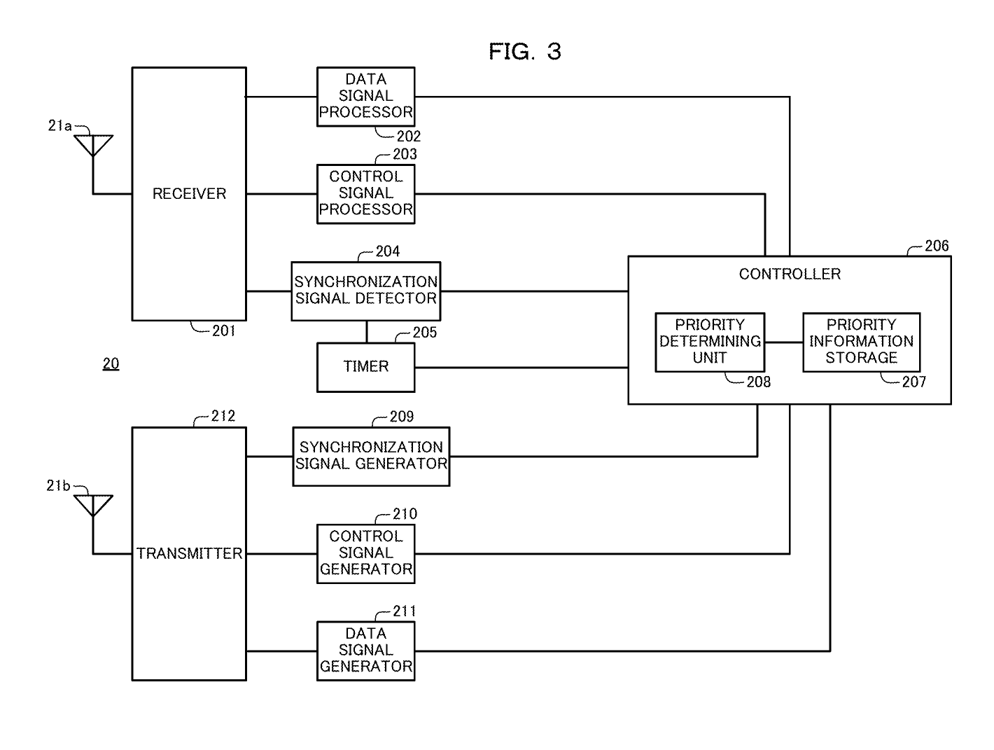

As illustrated in FIG. 3, the terminal 20 functionally includes a receiver 201, a data signal processor 202, a control signal processor 203, a synchronization signal detector 204, a timer 205 and a controller 206. The controller 206 includes, for example, a priority information storage 207 and a priority determining unit 208. Further, the terminal 20 functionally includes a synchronization signal generator 209, a control signal generator 210, a data signal generator 211 and a transmitter 212.

In the present embodiment, the receiver 201 and the transmitter 212 are realized by the RF circuit 24. Further, in the present embodiment, the antenna 21 includes a reception antenna 21a and a transmission antenna 21b. In addition, the antenna 21 includes a duplexer, and one antenna may be shared by the duplexer for transmission and reception.

In the present embodiment, the function units 202 to 211 different from the receiver 201 and the transmitter 212 among the functions of the terminal 20 are realized by the LSI 25. In addition, at least part of the function units 202 to 211 may be realized by the CPU 23 and the memory 22.

The receiver 201 executes a reception process for a radio signal received via the reception antenna 21a, and outputs an execution result as a received signal. For example, the reception process includes amplifying a radio signal, converting (in other words, down-converting) a radio frequency into a base frequency and converting an analog signal into a digital signal.

Hereinafter, a communication state of the terminal 20 will be described. In the present embodiment, the communication state of the terminal 20 includes first to third communication states.

In the first communication state, the terminal 20 receives a synchronization signal transmitted at the base station 10 without transmitting a synchronization signal, and communicates with the base station 10 based on the received synchronization signal.

In the second communication state, the terminal 20 receives a synchronization signal transmitted at the another terminal 20 without transmitting a synchronization signal, and communicates with the another terminal 20 or the still another terminal 20 whose communication state is the second communication state based on the received synchronization signal. That the communication state of the terminal 20 is the second communication state is an example where the terminal 20 is used as a cluster member.

In the third communication state, the terminal 20 transmits a synchronization signal, and communicates with the another terminal 20 which has received the synchronization signal. That the communication state of the terminal 20 is the third communication state is an example where the terminal 20 is used as a cluster head.

Next, an operation mode of the terminal 20 will be described.

In the present embodiment, the terminal 20 operates in one operation mode among a plurality of operation modes. A plurality of operation modes includes a first operation mode and a second operation mode.

In the present embodiment, when the terminal 20 operates in the first operation mode, the communication state of the terminal 20 is the first or second communication state. Hence, in the present embodiment, when the terminal 20 operates in the first operation mode, the terminal 20 is sometimes used as a cluster member.

Further, in the present embodiment, when the terminal 20 operates in the second operation mode, the communication state of the terminal 20 is the third communication state. Hence, in the present embodiment, when the terminal 20 operates in the second operation mode, the terminal 20 is used as a cluster head.

The first operation mode is an operation mode that the terminal 20 communicates with the base station 10 or the another terminal 20 operating in the first operation mode or the second operation mode. In the first operation mode, the terminal 20 receives a synchronization signal from the base station 10 or the another terminal 20 operating in the second operation mode. Further, in the first operation mode, the terminal 20 identifies a wireless area based on the received synchronization signal, and synchronizes a communication timing with that of the base station 10 or the another terminal 20 forming this wireless area.

In addition, in the first operation mode, in the wireless area with the synchronized communication timing, the terminal 20 performs wireless communication with the base station 10 and the another terminal 20 operating in the first operation mode or the second operation mode. This wireless communication is performed by using radio resources allocated by the base station 10 or the another terminal 20 forming the above wireless area.

An example where the terminal 20 performs wireless communication by using radio resources allocated by the another terminal 20 forming a wireless area is described herein. By the way, the terminal 20 may select radio resources to be used by the local terminal 20, from a predetermined radio resource candidate (also referred to as a resource pool). In this case, the terminal 20 may perform wireless communication with the another terminal 20 operating in the first operation mode or the second operation mode by using the selected radio resources.

The second operation mode is an operation mode that the terminal 20 communicates with the another terminal 20 operating in the first operation mode. In the second operation mode, the terminal 20 transmits a synchronization signal. Further, in the second operation mode, the terminal 20 allocates radio resources to other terminals 20 positioned in a wireless area formed by the local terminal 20. In addition, in the second operation mode, the terminal 20 performs wireless communication with the another terminal 20 by using radio resources allocated to the another terminal 20.

The data signal processor 202 processes a data signal from the radio resources allocated to the local terminal 20 by the base station 10 or the another terminal 20 in the first operation mode.

Further, the data signal processor 202 processes a data signal from radio resources allocated to the another terminal 20 by the local terminal 20 in the second operation mode.

In the present embodiment, the data signal processor 202 executes a demodulation/decoding process for the data signal. In the present embodiment, the demodulation/decoding process includes a process of demodulating a data signal, and an error correction decoding process based on an error correction coding performed on a data signal. In addition, the demodulation/decoding process may include an error detection process based on an error detection code added to a data signal.

The control signal processor 203 processes a control signal from the radio resources allocated by the base station 10 or the another terminal 20 in the first operation mode.

Further, the control signal processor 203 processes the control signal from the radio resources allocated by the local terminal 20 in the second operation mode.

In the present embodiment, the control signal processor 203 executes a demodulation/decoding process for the control signal. In the present embodiment, the demodulation/decoding process includes a process of demodulating a control signal, and an error correction decoding process based on an error correction coding performed on the control signal. In addition, the demodulation/decoding process may include an error detection process based on an error detection code added to a control signal.

The synchronization signal detector 204 detects a synchronization signal based on the received signal output by the receiver 201. The synchronization signal detector 204 outputs the detection result.

The synchronization signal detector 204 determines whether or not a state where a synchronization signal is not detected continues for a certain determination time or more, by using the timer 205 in the first operation mode. In the present embodiment, the determination time has a predetermined value. The synchronization signal detector 204 outputs the determination result in the first operation mode.

The controller 206 identifies a wireless area based on a detection result from the synchronization signal detector 204 in the first operation mode. Further, the controller 206 performs control to synchronize a communication timing with that of the base station 10 or the another terminal 20 forming the above wireless area, based on the detection result from the synchronization signal detector 204 in the first operation mode.

In addition, the controller 206 performs control to perform wireless communication with the base station 10 or the another terminal 20 by using the radio resources allocated by the base station 10 or the another terminal 20 forming the above wireless area in the first operation mode.

Further, the controller 206 switches the operation mode of the terminal 20 to the second operation mode when the determination result from the synchronization signal detector 204 indicates that the state where the synchronization signal is not detected continues for the determination time or more in the first operation mode.

When the controller 206 switches the operation mode of the terminal 20 from the first operation mode to the second operation mode, the priority determining unit 208 determines a priority of the local terminal 20.

As described below, the terminal 20 having a higher priority can more easily select the second operation mode for transmitting a synchronization signal. In other words, the terminal 20 having a lower priority can easily select the first operation mode for not transmitting a synchronization signal. Thus, the priority represents an extent of the priority of transmission of a synchronization signal at the terminal 20 in place of the base station 10. The priority is an example of information related to transmission of a synchronization signal transmitted in place of the base station 10.

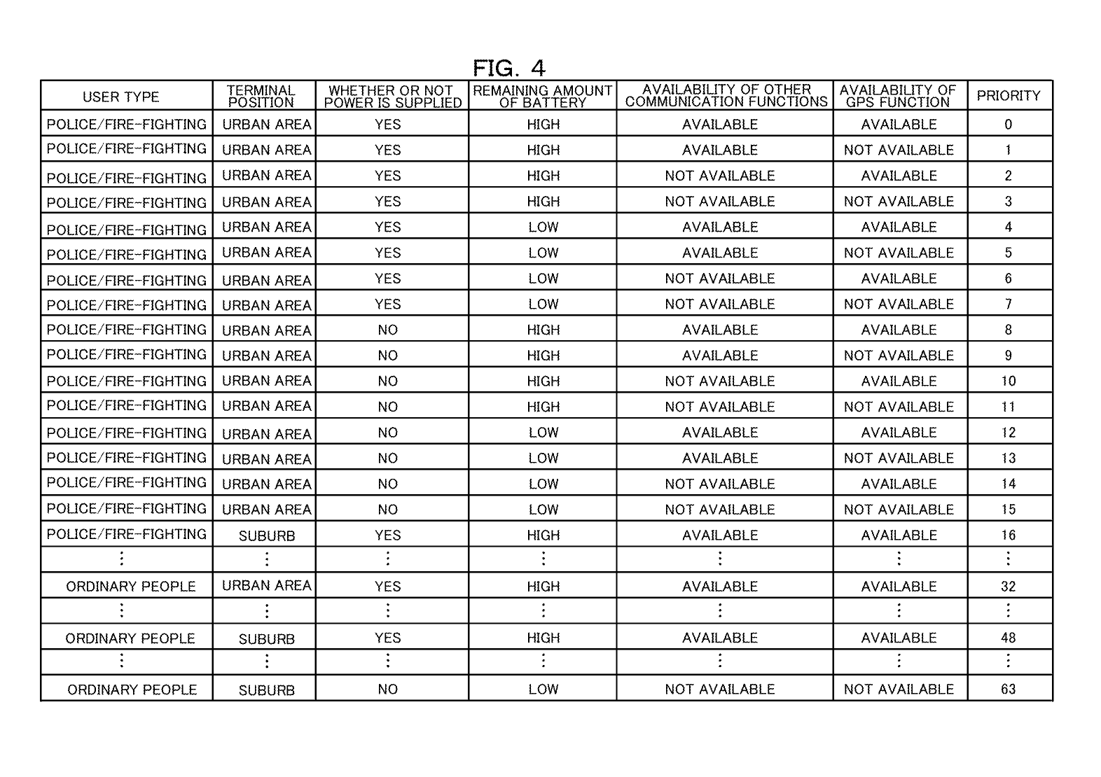

The priority information storage 207 stores in advance priority information indicating a relationship between information related to the terminal 20 and a priority. Storage of priority information is an example where priority information is held. As illustrated in FIG. 4, in the present embodiment, priority information is table format data. Further, in the present embodiment, a priority is higher as a value is smaller. The priority information may be distributed to each terminal 20 in the wireless communication system 1.

The information related to the terminal 20 illustratively includes a user type, a terminal position, whether or not power is supplied, a remaining amount of a battery, availability of other communication functions and availability of a GPS function. The GPS is an abbreviation of a Global Positioning System.

The user type represents a type of a user who possesses the terminal 20. Whether or not power is supplied represents whether or not power is supplied to the terminal 20. The remaining amount of the battery represents remaining power of the battery of the terminal 20. The availability of other communication functions represents whether or not the terminal 20 can use communication schemes different from a communication scheme used to perform wireless communication with the base station 10. The availability of the other communication functions is an example where the number of communication schemes which the terminal 20 can use is two or more. For example, the other communication functions may be functions which comply with wireless LAN (Local Area Network) systems. The availability of the GPS function represents whether or not the terminal 20 includes the GPS function.

The information related to the terminal 20 may include at least one of whether the terminal 20 is positioned indoor or outdoor, a speed at which the terminal 20 moves, performance of the antenna of the terminal 20, transmission power of the terminal 20 and a billing state of the terminal 20. For example, the terminal 20 may obtain the number of GPS satellites which are transmission sources of GPS signals based on received GPS signals, and determine whether the terminal 20 is positioned indoor or outdoor, based on the obtained number of GPS satellites.

Further, the information related to the terminal 20 may be a combination of one or two or more pieces of the information illustrated above.

The type of the user whose possesses the terminal 20, and adequacy that the terminal 20 is used as a cluster head are correlated. When, for example, performance of the terminal 20 differs, the terminals 20 which police officers, firefighters or civil servants possess are sometimes more suitably used as cluster head than the terminals 20 which ordinary people possess. The performance of the terminal 20 is, for example, a security strength, an information processing speed or a communication speed.

The position of the terminal 20, and adequacy that the terminal 20 is used as a cluster head are correlated. For example, the terminal 20 positioned in an urban area tends to have a larger number of the other communicable terminals 20 than the terminal 20 positioned in a suburb, and therefore is sometimes suitably used as a cluster head. Further, as, for example, a height of the terminal 20 is higher, a probability that an obstacle exists lowers. Hence, as the height is higher, the terminal 20 tends to have a larger number of other communicable terminals 20, and therefore is sometimes suitably used as a cluster head.

Whether the terminal 20 is positioned indoor or outdoor, and adequacy that the terminal 20 is used as a cluster head are correlated. For example, the terminal 20 existing outdoor tends to have a larger number of other communicable terminals 20 than the terminals 20 existing indoor, and therefore is sometimes suitably used as a cluster head.

Whether or not power is supplied to the terminal 20, and adequacy that the terminal 20 is used as a cluster head are correlated. For example, the terminal 20 to which power is supplied is assumed to be able to operate for a longer period than the terminal 20 to which power is not supplied, and therefore is sometimes suitably used as a cluster head.

The remaining amount of the battery of the terminal 20, and adequacy that the terminal 20 is used as a cluster head are correlated. For example, as the remaining amount of the battery is higher, the terminal 20 is assumed to be able to operate for a longer period, and therefore is sometimes suitably used as a cluster head.

The speed at which the terminal 20 moves, and adequacy that the terminal 20 is used as a cluster head are correlated. For example, as the moving speed becomes slower, the terminal 20 is assumed to be able to maintain connection with cluster members for a longer period, and therefore is sometimes suitably used as a cluster head.

The performance of the antenna of the terminal 20, and adequacy that the terminal 20 is used as a cluster head are correlated. For example, as the performance of the antenna is higher, the terminal 20 tends to have a larger number of the other communicable terminals 20, and therefore is sometimes suitably used as a cluster head. For example, the performance of the antenna may be an antenna gain.

Further, the terminal 20 including the antenna which does not have directionality tends to have a larger number of the other communicable terminals 20 than the terminal 20 including the antenna which has directionality, and therefore is sometimes suitably used as a cluster head.

The transmission power of the terminal 20, and the adequacy that the terminal 20 is used as a cluster head are correlated. For example, as the transmission power is higher, the terminal 20 tends to have a larger number of the other communicable terminals 20, and therefore is sometimes suitably used as a cluster head.

The number of usable communication schemes by the terminal 20, and adequacy that the terminal 20 is used as a cluster head are correlated. For example, as the terminal 20 has a larger number of usable communication schemes, and therefore is sometimes suitably used as a cluster head since a probability that it is possible to communicate with another device by using one of the communication schemes is high.

The availability of the GPS function of the terminal 20, and adequacy that the terminal 20 is used as a cluster head are correlated. For example, the terminal 20 including the GPS function can obtain an accurate time which serves as a synchronization reference, by receiving a GPS signal, and therefore is sometimes suitably used as a cluster head.

The billing state of the terminal 20, and adequacy that the terminal 20 is used as a cluster head are correlated. For example, to what degree the terminal 20 is suitably used as a cluster head is sometimes determined according to a billing amount.

In the present embodiment, the priority determining unit 208 obtains information related to the terminal 20. For example, the priority determining unit 208 may detect whether or not power is supplied, and a remaining amount of the battery. For example, the priority determining unit 208 may store information indicating a user type, availability of other communication functions and availability of the GPS function in advance, and obtain the stored information.

The priority determining unit 208 determines a priority of the local terminal 20 based on the obtained information related to the terminal 20, and priority information stored in the priority information storage 207.

Consequently, the terminal 20 can appropriately determine the priority of the local terminal 20. Further, determination of the priority of the local terminal 20 based on the priority information is an example where the priority of the local terminal 20 is determined according to a certain rule.

Thus, the terminal 20 determines the priority of the local terminal 20 related to transmission of a synchronization signal according to the certain rule when the synchronization signal is not received from the base station 10.

Consequently, a notification of a priority to the terminal 20 from the base station 10 can be made unnecessary. As a result, it is possible to effectively use radio resources.

The controller 206 determines whether or not a synchronization signal has been received from the another terminal 20 until a standby time passes after the operation mode of the terminal 20 is switched from the first operation mode to the second operation mode. The standby time may be set to a shorter time as the priority determined by the priority determining unit 208 is higher. In the present embodiment, the controller 206 stores in advance information indicating a relationship between the priority and the standby time, and determines the standby time based on the determined priority and the stored information.

When determining that the synchronization signal has been received from the another terminal 20 until the standby time passes after the operation mode is switched from the first operation mode to the second operation mode, the controller 206 switches the operation mode of the terminal 20 from the second operation mode to the first operation mode.

When determining that the synchronization signal has not been received from the another terminal 20 until the standby time passes after the operation mode is switched from the first operation mode to the second operation mode, the controller 206 controls the synchronization signal generator 209 to start transmitting synchronization signals.

Thus, the terminal 20 starts transmitting a synchronization signal when not receiving the synchronization signal until the standby time corresponding to the determined priority passes. In other words, the terminal 20 determines whether or not to transmit a synchronization signal in place of the base station 10 according to the priority.

Consequently, the terminal 20 having a higher priority can increase a probability that the terminal 20 is used as a cluster head. Further, it is possible to prevent synchronization signals from being unnecessarily transmitted.

The synchronization signal generator 209 generates a synchronization signal associated with the priority determined by the priority determining unit 208 in the second operation mode. In the present embodiment, the synchronization signal generator 209 associates a priority and an identifier for identifying a Zadoff-Chu sequence in advance to store, and generates a synchronization signal by using the Zadoff-Chu sequence identified based on the identifier associated with the determined priority. Consequently, the another terminal 20 having received the synchronization signal can recognize the priority associated with this synchronization signal.

The synchronization signal generator 209 outputs the generated synchronization signal to transmit the synchronization signal by using predetermined radio resources under control of the controller 206.

The control signal generator 210 generates a control signal indicating control information. In the present embodiment, the control signal generator 210 executes a coding/modulation process for the generated control signal. In the present embodiment, the coding/modulation process includes a process of performing error correction coding for a control signal and a process of modulating the control signal. In addition, the coding/modulation process may include a process of adding an error detection code for the control signal.

The control signal generator 210 outputs the generated control signal to transmit the control signal by using radio resources allocated to the local terminal 20 by the base station 10 or the another terminal 20 in the first operation mode.

Further, the control signal generator 210 outputs the generated control signal to transmit the control signal by using the radio resources allocated to the another terminal 20 by the local terminal 20 in the second operation mode.

The data signal generator 211 generates a data signal indicating user data. In the present embodiment, the data signal generator 211 executes a coding/modulation process for the generated data signal. In the present embodiment, the coding/modulation process includes a process of performing error correction coding for a data signal and a process of modulating the data signal. In addition, the coding/modulation process may include a process of adding an error detection code for the data signal.

The data signal generator 211 outputs the generated data signal to transmit the data signal by using the radio resources allocated to the local terminal 20 by the base station 10 or the another terminal 20 in the first operation mode.

Further, the data signal generator 211 outputs the generated data signal to transmit the data signal by using the radio resources allocated to the another terminal 20 by the local terminal 20 in the second operation mode.

The transmitter 212 executes a transmission process for signals output from each of the function units 209 to 211, and transmits a radio signal which is an execution result via the transmission antenna 21b. For example, the transmission process includes converting a digital signal into an analog signal, converting a base frequency into a radio frequency (in other words, up-conversion) and amplifying the radio signal.

(Operation)

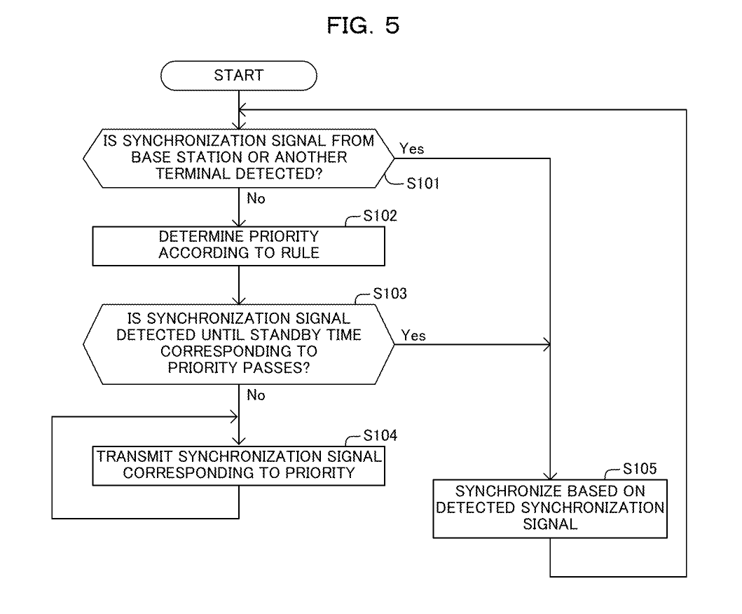

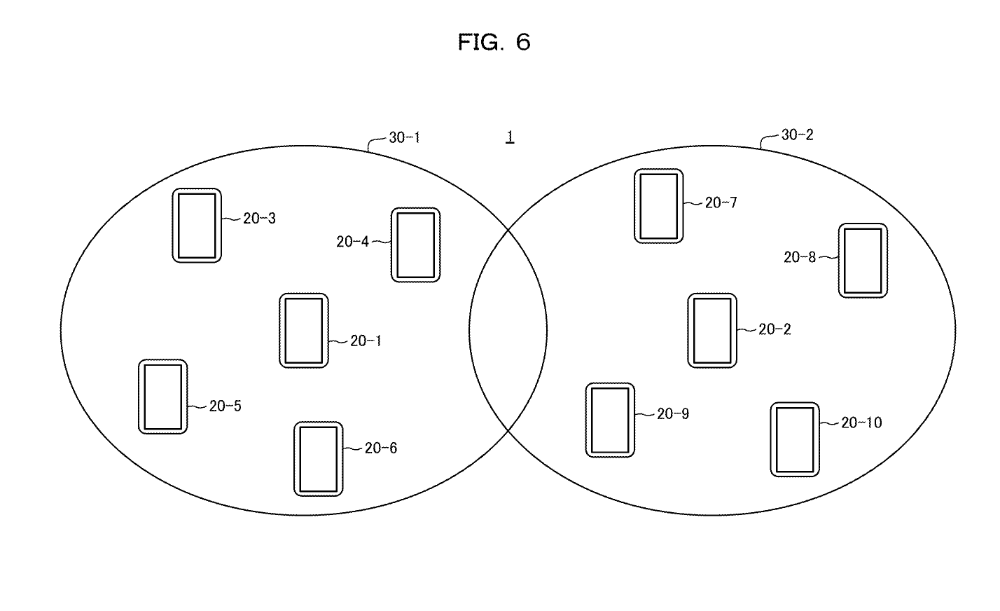

Next, an operation of the wireless communication system 1 will be described with reference to FIGS. 5 and 6. Hereinafter, part of the operation of the wireless communication system 1 related to transmission of a synchronization signal at the terminal 20 will be described.

As illustrated in the flowchart in FIG. 5, the terminal 20 determines whether or not a synchronization signal from the base station 10 or the another terminal 20 is detected until the determination time passes when the terminal 20 operates in the first operation mode (step S101 in FIG. 5).

In this regard, it is assumed that the terminal 20 does not detect a synchronization signal from the base station 10 or the another terminal 20 until the determination time passes. In this case, the terminal 20 determines “No”, and determines a priority according to the rule (step S102 in FIG. 5). In the present embodiment, the terminal 20 obtains information related to the terminal 20, and determines the priority based on the obtained information and the stored priority information.

That the synchronization signal is not detected until the determination time passes represents that a state where the synchronization signal is not detected continues for the determination time or more. In the present embodiment, that the terminal 20 determines No in step S101 in FIG. 5 represents that the operation mode of the terminal 20 is switched from the first operation mode to the second operation mode. In the present embodiment, the terminal 20 determines a priority based on the stored priority information. In addition, the processes in steps S101 and S102 in FIG. 5 may be executed in order reverse to the order illustrated in FIG. 5.

Next, the terminal 20 determines whether or not a synchronization signal from the another terminal 20 is detected until the standby time corresponding to the determined priority passes (step S103 in FIG. 5).

Hereinafter, a case where the synchronization signal from the another terminal 20 is not detected until the standby time passes will be assumed. In this case, the terminal 20 determines “No”, and transmits a synchronization signal corresponding to the priority (step S104 in FIG. 5). Subsequently, the terminal 20 continues transmitting synchronization signals.

In addition, the terminal 20 determines “Yes” when detecting the synchronization signal from the base station 10 or the another terminal 20 until the determination time passes in step S101 in FIG. 5. In this case, the terminal 20 synchronizes a communication timing with that of the base station 10 or the another terminal 20 which has transmitted the synchronization signal, based on the detected synchronization signal (step S105 in FIG. 5). Subsequently, the terminal 20 returns to step S101 in FIG. 5 to repeatedly execute the processes in steps S101 to S105.

Further, the terminal 20 determines “Yes” when detecting the synchronization signal from the another terminal 20 until the standby time passes in step S103 in FIG. 5. In the present embodiment, that the terminal 20 determines “Yes” in step S103 in FIG. 5 represents that the operation mode of the terminal 20 is switched from the second operation mode to the first operation mode. In this case, the terminal 20 synchronizes a communication timing with that of the base station 10 or the another terminal 20 which has transmitted a synchronization signal, based on the detected synchronization signal (step S105 in FIG. 5). Subsequently, the terminal 20 returns to step S101 in FIG. 5 to repeatedly execute the processes in steps S101 to S105.

For example, a case where, as illustrated in FIG. 6, the wireless communication system 1 includes the ten terminals 20-1, 20-2, . . . and 20-10 will be assumed. In this case, a case where each terminal 20 fails to receive a synchronization signal from the base station 10 will be assumed.

Further, in this case, a case where the priorities of the terminals 20-1 and 20-2 are higher than priorities of the other terminals 20-3, 20-4, . . . , and 20-10 will be assumed. In this case, the terminals 20-1 and 20-2 start transmitting synchronization signals earlier than the other terminals 20-3, 20-4, . . . and 20-10.

In the present embodiment, a case where the other terminals 20-3, 20-4, . . . and 20-6 are positioned in a wireless area 30-1 formed by the terminal 20-1 will be assumed. Further, in the present embodiment, a case where the other terminals 20-7, 20-8, . . . and 20-10 are positioned in a wireless area 30-2 formed by the terminal 20-2 will be assumed.

In this case, the other terminals 20-3, 20-4, . . . and 20-10 receive synchronization signals from the terminal 20-1 or 20-2 until the standby time passes.

Hence, in the present embodiment, the terminals 20-1 and 20-2 operate in the second operation mode. Further, the other terminals 20-3, 20-4, . . . and 20-10 operate in the first operation mode.

As described above, in the wireless communication system 1 according to the first embodiment, each of a plurality of terminals 20 determines the priority of the local terminal 20 related to transmission of a synchronization signal according to the certain rule when not receiving a synchronization signal from the base station 10.

Consequently, a notification of the priority to the terminal 20 from the base station 10 can be made unnecessary. As a result, it is possible to effectively use radio resources.

In addition, the terminal 20 may determine the priority based on information input by a user of the local terminal 20.

Further, each synchronization signal need not to be associated with a priority. In this case, information indicating a priority may be transmitted together with each synchronization signal.

### Modified Example 1 of First Embodiment

Next, a wireless communication system according to Modified Example 1 of the first embodiment of the present invention will be described. The wireless communication system according to Modified Example 1 of the first embodiment differs from the wireless communication system according to the first embodiment in assigning weights to a plurality of pieces of element information included information related to each terminal, and determining a priority. Such a difference will be mainly described below. In addition, in description of Modified Example 1 of the first embodiment, components assigned the same reference numerals as those used in the first embodiment will be identical or substantially same components.

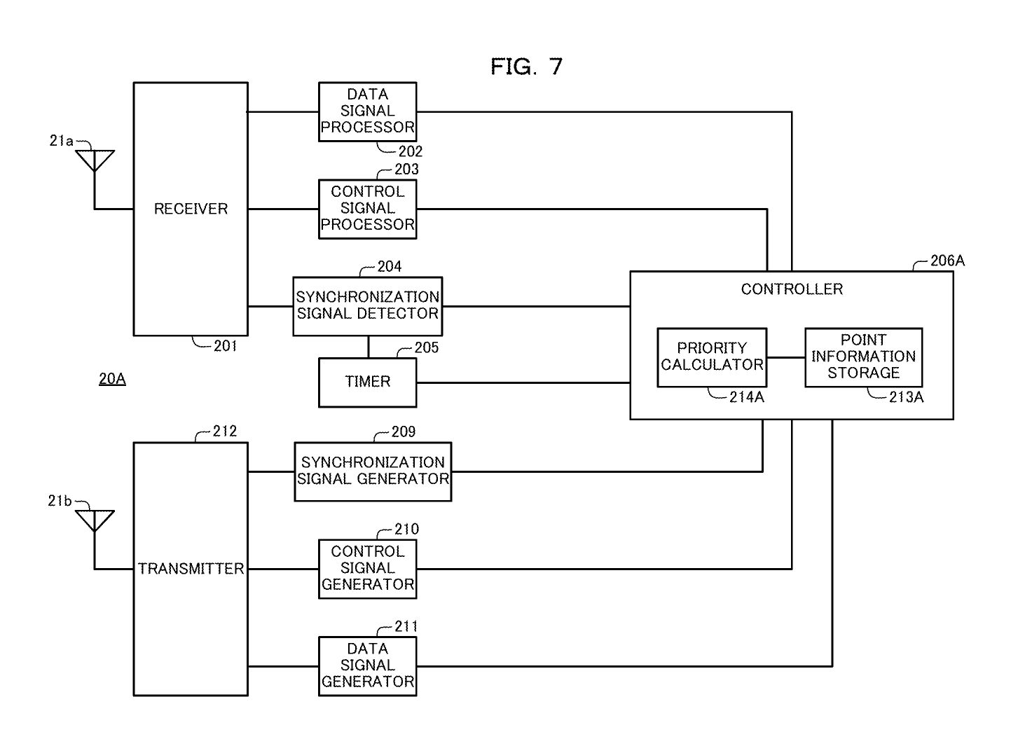

As illustrated in FIG. 7, a terminal 20A according to Modified Example 1 functionally includes a controller 206A instead of the controller 206 in FIG. 3. The controller 206A includes the same functions as those of the controller 206 except that the controller 206A includes a point information storage 213A and a priority calculator 214A instead of the priority information storage 207 and the priority determining unit 208.

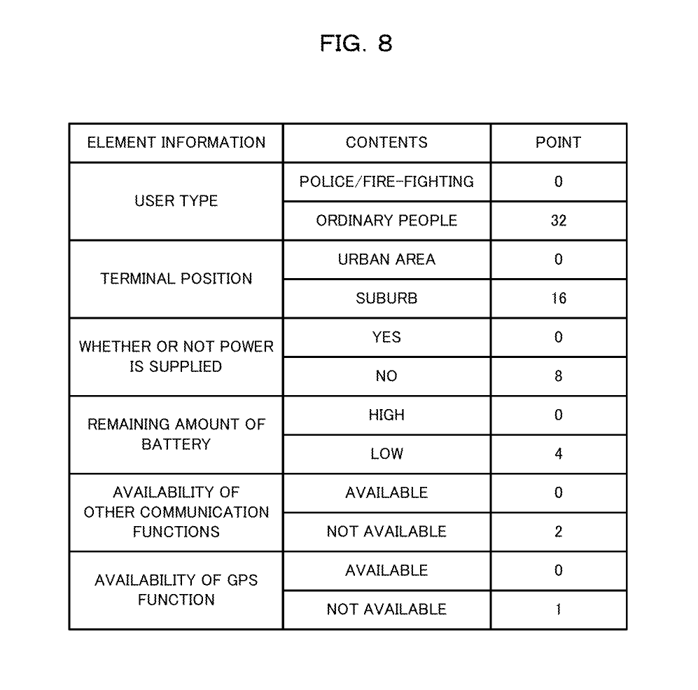

The point information storage 213A stores in advance point information indicating a relationship between information contents and points for each of a plurality of pieces of element information included in the information related to the terminal 20A. Storage of the point information is an example where point information is held. As illustrated in FIG. 8, in this example, the point information is table format data.

The priority calculator 214A calculates a total sum of points for a plurality of pieces of element information based on the relationship stored in the point information storage 213A. The priority calculator 214A determines the priority based on the calculated total sum of the points. In this example, the priority calculator 214A determines the calculated total sum of the points as the priority. Determination of the priority based on the total sum of the points is an example where weights are assigned to a plurality of pieces of element information included in the information related to the terminal 20A and determining a priority.

By the way, an influence on adequacy that the terminal 20A is used as a cluster head differs per element information. Consequently, the terminal 20A according to Modified Example 1 can reflect the difference of the influence in the priority. As a result, it is possible to appropriately determine the priority.

### Modified Example 2 of First Embodiment

Next, a wireless communication system according to Modified Example 2 of the first embodiment of the present invention will be described. The wireless communication system according to Modified Example 2 of the first embodiment differs from the wireless communication system according to the first embodiment in determining a priority based on a pseudo random number. Such a difference will be mainly described below. In addition, in description of Modified Example 2 of the first embodiment, components assigned the same reference numerals as those used in the first embodiment will be identical or substantially same components.

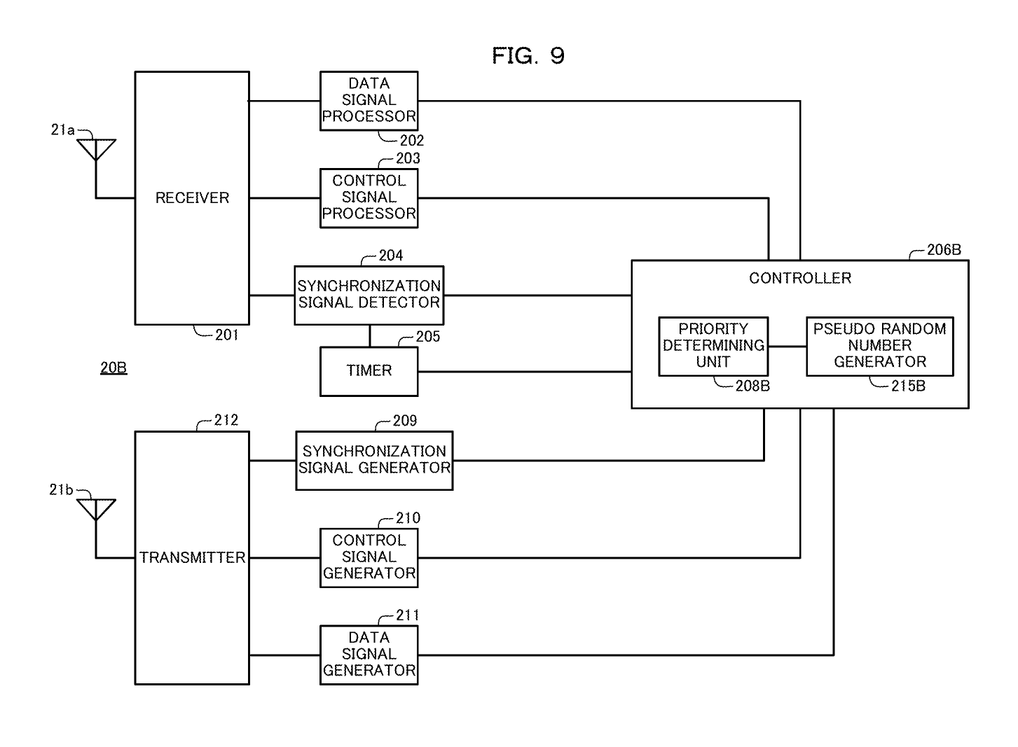

As illustrated in FIG. 9, a terminal 20B according to Modified Example 2 functionally includes a controller 206B instead of the controller 206 in FIG. 3. The controller 206B includes the same functions as those of the controller 206 except that the controller 206B includes a pseudo random number generator 215B and a priority determining unit 208B instead of the priority information storage 207 and the priority determining unit 208.

The pseudo random number generator 215B generates pseudo random numbers. In this example, the pseudo random number generator 215B generates a pseudo random number by using as a seed a combination of a terminal identifier for identifying the terminal 20B and a current time.

The priority determining unit 208B determines a priority based on the pseudo random number generated by the pseudo random number generator 215B. For example, the priority determining unit 208B may store in advance information indicating a relationship between a pseudo random number and a priority, and determine a priority based on the stored information and the generated pseudo random number. Further, the priority determining unit 208B may determine the generated pseudo random number as a priority.

The terminal 20B according to Modified Example 2 can reduce a probability that the priorities match between the terminals 20B. As a result, it is possible to prevent synchronization signals from being unnecessarily transmitted.

Further, in this example, as the number of values of pseudo random numbers to be generated is larger, it is possible to further reduce the probability that the priorities match between the terminals 20B.

### Modified Example 3 of First Embodiment

Next, a wireless communication system according to Modified Example 3 of the first embodiment of the present invention will be described. The wireless communication system according to Modified Example 3 of the first embodiment differs from the wireless communication system according to the first embodiment in determining a priority based on the number of communicable terminals. Such a difference will be mainly described below. In addition, in description of Modified Example 3 of the first embodiment, components assigned the same reference numerals as those used in the first embodiment will be identical or substantially same components.

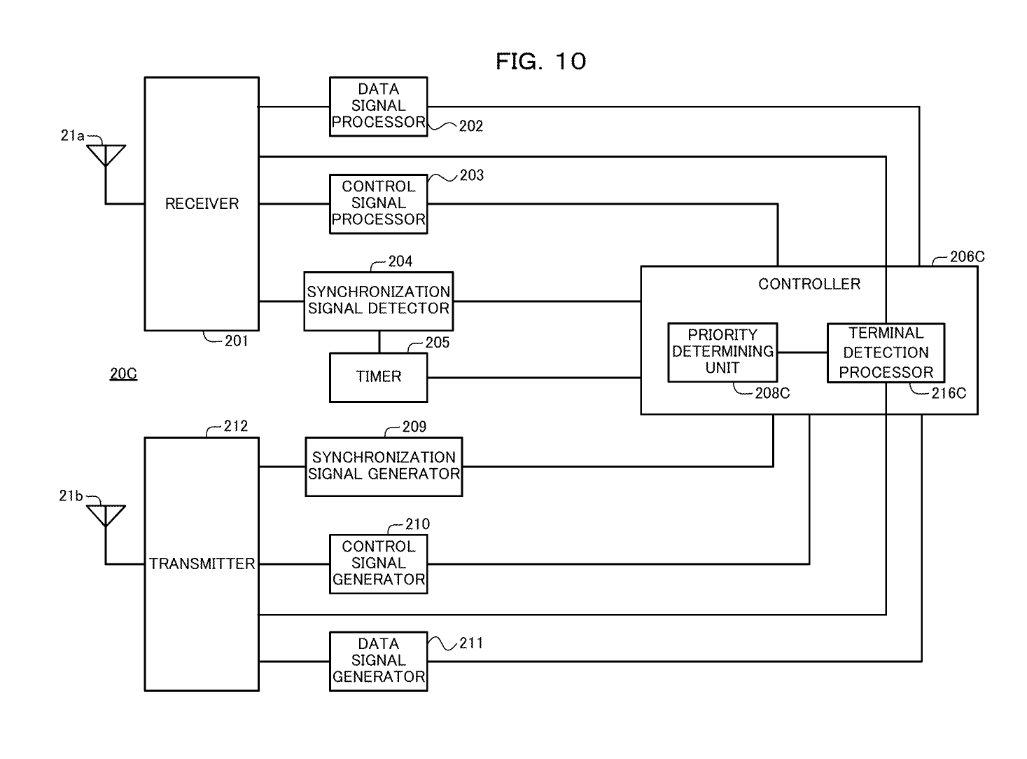

As illustrated in FIG. 10, a terminal 20C according to Modified Example 3 functionally includes a controller 206C instead of the controller 206 in FIG. 3. The controller 206C includes the same functions as those of the controller 206 except that the controller 206C includes a terminal detection processor 216C and a priority determining unit 208C instead of the priority information storage 207 and the priority determining unit 208.

The terminal detection processor 216C executes a terminal detection process. The terminal detection process is a process of detecting the other terminals 20C which can communicate with the local terminal 20C. The terminal detection process may be referred to as D2D Discovery.

In this example, the terminal detection process includes a process of generating a probe signal (also referred to as a discovery signal), and outputting the generated probe signal to the transmitter 212 to transmit the probe signal. The other terminals 20C transmit response signals in response to reception of the probe signal. In addition, information related to a probe signal may be broadcast or may be notified by using a paging signal. For example, the information related to the probe signal includes a timing to transmit the probe signal, and information for identifying the probe signal.

Further, the terminal detection process includes a process of detecting the other terminals 20C which can communicate with the local terminal 20C by detecting a response signal from a received signal output by the receiver 201.

The terminal detection processor 216C outputs the number of detected terminals. The number of detected terminals is a number of the other terminals 20C which can communicate with the local terminal 20C detected by the terminal detection process.

In addition, the terminal detection processor 216C may execute the terminal detection process in the first operation mode.

The priority determining unit 208C determines a priority based on the number of detected terminals output by the terminal detection processor 216C. In this example, the priority determining unit 208C determines a higher priority as the number of detected terminals is larger.

Consequently, it is possible to reduce the number of cluster heads. Thus, it is possible to reduce radio resources used to perform communication between cluster heads and control cluster heads, for example.

In this example, the priority determining unit 208C stores in advance information indicating a relationship between the number of detected terminals and a priority, and determines the priority based on the stored information and the number of detected terminals output by the terminal detection processor 216C.

Thus, the terminal 20C according to Modified Example 3 executes a process of detecting the other terminals 20C, and determines a priority of the local terminal 20C based on the number of the other terminals 20C detected by this process.

Consequently, it is possible to reflect the number of the terminals 20C with which the each terminal 20C can communicate in the priority. Consequently, it is possible to appropriately determine the priority.

In addition, the terminal 20C may determine a higher priority as the number of the other terminals 20C which have detected the local terminal 20C by the terminal detection process is larger.

In this case, the terminal 20C may detect the other terminals 20C which have transmitted a probe signal as the other terminals 20C which have detected the local terminal 20C by the terminal detection process by detecting the probe signal from a received signal. In addition, the probe signal may include an identifier for identifying the transmission source terminal 20C. Further, the terminal 20C may obtain the number of received probe signals as the number of the other terminals 20C which have detected the local terminal 20C by the terminal detection process.

Consequently, it is possible to reduce the number of cluster heads. Thus, it is possible to reduce radio resources used to perform communication between cluster heads and control cluster heads, for example.

### Second Embodiment

Next, a wireless communication system according to the second embodiment of the present invention will be described. The wireless communication system according to the second embodiment differs from the wireless communication system according to the first embodiment in changing a priority according to a state of each terminal. Such a difference will be mainly described below. In addition, in description of the second embodiment, components assigned the same reference numerals as those used in the first embodiment will be identical or substantially same components.

When a state of each terminal changes after a priority order is determined in wireless communication systems disclosed in Patent Literatures 1 to 11 and Non Patent Literature 1, each terminal fails to reflect this change in the priority order.

By the way, when a terminal serving as a cluster head is changed, radio resources are used by each cluster member to change a terminal which is to be a destination of connection. When the priority order fails to be appropriately determined, a terminal serving as a cluster head is frequently changed in some cases. Hence, in this case, radio resources used by each cluster member to change a terminal which is to be a destination of connection tend to be larger.

Further, when the priority order fails to be appropriately determined, the number of cluster heads tends to be larger. As the number of cluster heads is larger, radio resources used to perform communication between cluster heads and control cluster heads, for example, are greater. Further, in the above wireless communication systems, a synchronization signal is unnecessarily transmitted in some cases.

Thus, in the above wireless communication systems, it is difficult to effectively utilize radio resources in some cases. By contrast with this, in the present embodiment, radio resources are effectively used.

The wireless communication system according to the second embodiment will be described in detail below.

(Function)

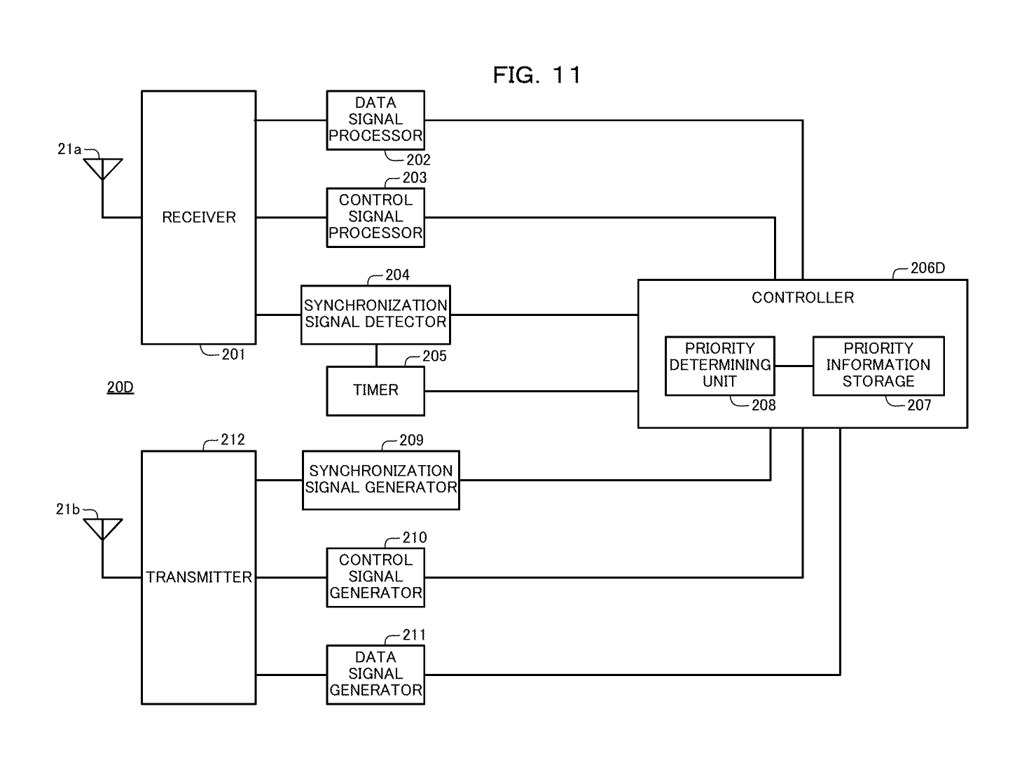

As illustrated in FIG. 11, a terminal 20D according to the second embodiment functionally includes a controller 206D instead of the controller 206 in FIG. 3. The controller 206D includes the same functions as those of the controller 206 except for performing control to change a priority of the local terminal 20D and stop transmitting synchronization signals.

The controller 206D changes the priority determined by the priority determining unit 208 according to a state of the local terminal 20D.

In the present embodiment, the controller 206D makes the priority of the local terminal 20D higher as a time from starting transmitting a synchronization signal at the local terminal 20D is longer.

The terminal 20D which has passed a longer time from starting transmitting a synchronization signal has a larger number of the other terminals 20D which change operation modes and a larger number of cluster members which change the terminal 20D which is to be a destination of connection in response to a change from a cluster head to a cluster member.

By contrast with this, according to the terminal 20D according to the second embodiment, the terminal 20D which has passed a longer time from starting transmitting a synchronization signal is hardly changed from a cluster head to a cluster member. Thus, the terminal 20D serving as a cluster head is hardly frequently changed. Further, it is thus possible to reduce the number of the terminals 20D which change operation modes and the number of cluster members which change the terminal 20D which is to be a destination of connection. As a result, it is possible to reduce radio resources used by each cluster member to change the terminal 20D which is to be a destination of connection. Consequently, it is possible to effectively use radio resources.

For example, the controller 206D stores in advance information indicating a relationship between a time and a priority, and updates the priority based on the stored information and a time from starting transmitting synchronization signals at the local terminal 20D.

Further, for example, the controller 206D may subtract a certain change from the priority every time a certain update cycle passes.

Furthermore, the controller 206D determines whether or not synchronization signals from the other terminals 20D have been detected, based on the detection result from the synchronization signal detector 204 in the second operation mode. When determining that the synchronization signals from the other terminals 20D have been detected, the controller 206D controls transmission of a synchronization signal at the local terminal 20D based on the priority associated with each of the detected synchronization signals.

Consequently, the terminal 20D having a higher priority can increase a probability that the terminal 20D having a higher priority is used as a cluster head. Further, it is possible to prevent synchronization signals from being unnecessarily transmitted.

In the present embodiment, the controller 206D switches the operation mode from the second operation mode to the first operation mode when the priority associated with each of the detected synchronization signals is higher than the priority of the local terminal 20D. Hence, in this case, the controller 206D stops transmitting synchronization signals at the local terminal 20D.

Meanwhile, the priority associated with each of the detected synchronization signals is lower than the priority of the local terminal 20D, the controller 206D maintains the second operation mode as the operation mode. Hence, in this case, the controller 206D continues transmitting synchronization signals at the local terminal 20D.

Consequently, the terminal 20D having a higher priority can increase a probability that the terminal 20D having a higher priority is used as a cluster head. Further, it is possible to prevent synchronization signals from being unnecessarily transmitted.

In addition, when the priority associated with each of the detected synchronization signals is higher than the priority of the local terminal 20D, the controller 206D may continue transmitting synchronization signals without switching the operation mode, and decrease synchronization signal transmission power.

(Operation)

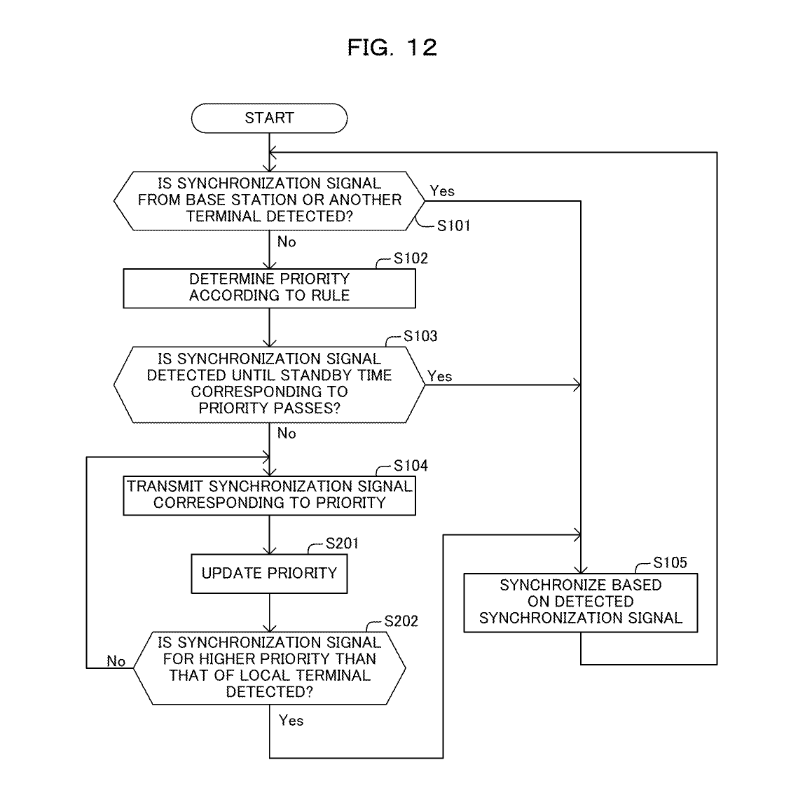

Next, an operation of the terminal 20D according to the second embodiment will be described with reference to FIG. 12.

The terminal 20D according to the second embodiment executes a process additionally including steps S201 and S202 in FIG. 12 subsequent to step S104 in FIG. 5 instead of the process in FIG. 5. In addition, step S201 may be executed before step S104.

The terminal 20D transmits a synchronization signal (step S104 in FIG. 12), and then updates the priority of the local terminal 20D (step S201 in FIG. 12). In the present embodiment, the terminal 20D updates the priority of the local terminal 20D to make the priority of the local terminal 20D higher as a time from starting transmitting synchronization signals at the local terminal 20D is longer.

Next, the terminal 20D determines whether or not a synchronization signal associated with a higher priority than the priority of the local terminal 20D has been detected (step S202 in FIG. 12).

Hereinafter, a case where a synchronization signal associated with a higher priority than the priority of the local terminal 20D will be assumed. In this case, the terminal 20D determines “Yes”, and moves to step S105 in FIG. 12. In the present embodiment, that the terminal 20D determines “Yes” in step S202 in FIG. 12 represents that the operation mode of the terminal 20D is switched from the second operation mode to the first operation mode. Hence, in this case, the terminal 20D stops transmitting synchronization signals.

Further, when not detecting a synchronization signal associated with a higher priority than the priority of the local terminal 20D in step S202 in FIG. 12, the terminal 20D determines “No”, and returns to step S104 in FIG. 12. In this case, the operation mode of the terminal 20D is maintained as the second operation mode. Hence, the terminal 20D continues transmitting synchronization signals.

As described above, the terminal 20D according to the second embodiment changes the priority determined by the priority determining unit 208 according to a state of the local terminal 20D.

Consequently, it is possible to reflect the change in the state of the terminal 20D in the priority. Thus, it is possible to use an appropriate priority corresponding to the state of the terminal 20D. As a result, it is possible to reduce a frequency that a cluster head is changed. Further, it is possible to reduce the number of cluster heads. As a result, it is possible to effectively use radio resources.

Furthermore, the terminal 20D according to the second embodiment controls transmission of a synchronization signal at the local terminal 20D based on priorities of the other terminals 20D in response to reception of synchronization signals from the other terminals 20D.

Consequently, the terminal 20D having a higher priority can increase the probability that the terminal 20D having a higher priority is used as a cluster head. Further, it is possible to prevent synchronization signals from being unnecessarily transmitted.

Furthermore, the terminal 20D which is used as a cluster head may make the priority of the local terminal 20D higher as the number of the other terminals 20D communicating with the local terminal 20D is larger.

For example, the number of the other terminals 20D communicating with the terminal 20D which is used as a cluster head may be obtained by sending a notification of an increase in cluster members by the terminal 20D which has received a synchronization signal to the terminal 20D which has transmitted this synchronization signal. In this case, this notification may be executed by executing a RA procedure. The RA is an abbreviation of a Random Access. For example, the RA procedure may be a competition-based or non-competition-based RA procedure.

Further, for example, the number of the other terminals 20D communicating with the terminal 20D which is used as a cluster head may be obtained by transmitting a certain probe signal by the terminal 20D which is used as a cluster head every time a certain cycle passes. In this case, the other terminals 20D may transmit response signals in response to reception of probe signals. Further, in this case, the terminal 20D which is used as a cluster head may obtain the above number of the other terminals 20D based on the received response signal.

Consequently, the terminal 20D which has more connected cluster members is more hardly changed from a cluster head to a cluster member. Accordingly, it is possible to reduce the number of cluster members which change the terminal 20D which is to be a destination of connection. As a result, it is possible to reduce radio resources used by cluster members to change the terminal 20D which is to be a destination of connection. Accordingly, it is possible to effectively use radio resources.

In addition, when updating a priority, the terminal 20D may broadcast the updated priority. Further, when updating a priority, the terminal 20D may transmit a synchronization signal associated with the updated priority.

In addition, the terminal 20D needs not to update the priority. Further, the terminal 20D may use a priority received from the base station 10 as the priority of the local terminal 20D without determining the priority of the local terminal 20D. Furthermore, the terminal 20D may continue transmitting synchronization signals when receiving synchronization signals from the other terminals 20D having higher priorities than the priority of the local terminal 20D in the second operation mode.

### Modified Example 1 of Second Embodiment

Next, a wireless communication system according to Modified Example 1 of the second embodiment of the present invention will be described. The wireless communication system according to Modified Example 1 of the second embodiment differs from the wireless communication system according to the second embodiment in notifying another terminal of a presence of one terminal when each terminal receives synchronization signals from each of a plurality of terminals. Such a difference will be mainly described below. In addition, in description of Modified Example 1 of the second embodiment, components assigned the same reference numerals as those used in the second embodiment will be identical or substantially same components.

(Function)

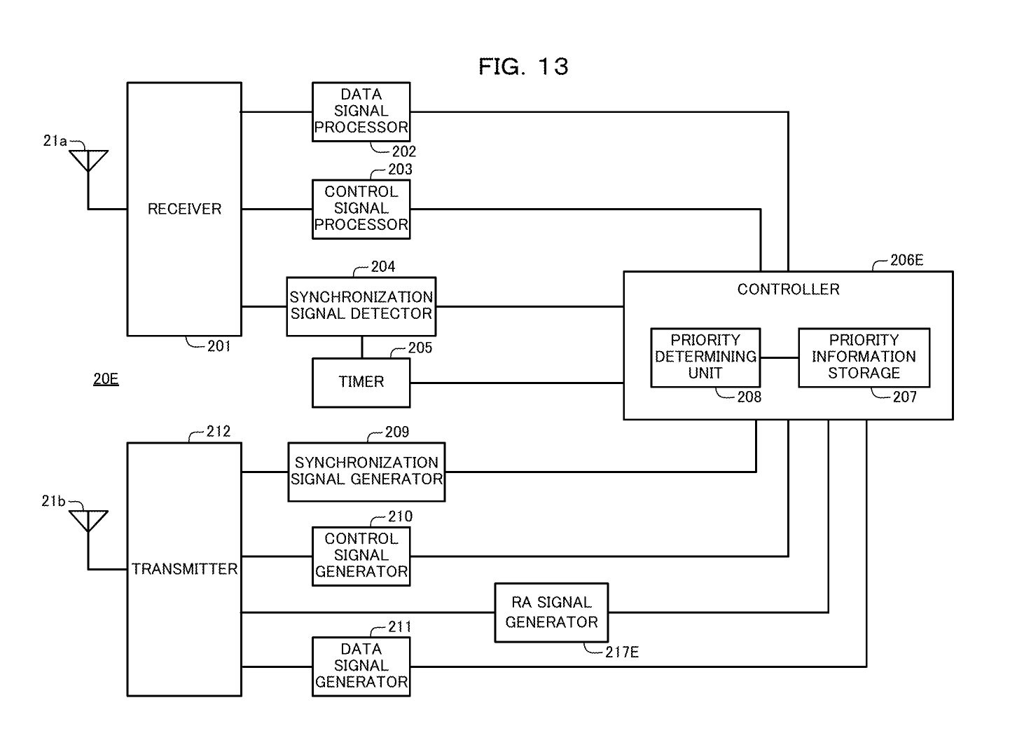

As illustrated in FIG. 13, a terminal 20E according to Modified Example 1 functionally includes an RA signal generator 217E in addition to the functions of the terminal 20D in FIG. 11. The RA is an abbreviation of a Random Access.

The RA signal generator 217E generates an RA signal for executing an RA procedure. For example, the RA procedure may be a competition-based or non-competition-based RA procedure. The RA signal generator 217E outputs a generated RA signal to transmit the RA signal by using predetermined radio resources under control of a controller 206E described below.

Further, the terminal 20E according to Modified Example 1 functionally includes the controller 206E instead of the controller 206D in FIG. 11.

In this regard, for ease of description, the terminal 20E of interest will be referred to as the first terminal 20E or the local terminal 20E, the terminal 20E different from the first terminal 20E will be referred to as the second terminal 20E, and the terminal 20E different from the first terminal 20E and the second terminal 20E will be referred to as the third terminal 20E.

The controller 206E has the same functions as those of the controller 206D except for first and second differences. The first difference is that, when receiving synchronization signals from each of the second terminal 20E and the third terminal 20E, a presence of one of the second terminal 20E and the third terminal 20E is notified to the other one of the second terminal 20E and the third terminal 20E. The second difference is that transmission of a synchronization signal at the local terminal 20E is controlled based on a notification from the terminal 20E different from the local terminal 20E.

In this example, the controller 206E determines whether or not another synchronization signal has been detected, based on a detection result from the synchronization signal detector 204 in the first operation mode.

In this regard, the another synchronization signal is a synchronization signal transmitted by the third terminal 20E different from the second terminal 20E which has transmitted a synchronization signal based on which the first terminal 20E determines to operate in the first operation mode. For example, a case where the first terminal 20E receives a synchronization signal from the second terminal 20E different from the local terminal 20E, and determines to operate in the first operation mode in response to reception of the synchronization signal will be assumed. In this case, a case where the first terminal 20E receives a synchronization signal from the third terminal 20E, too, will be assumed. In this case, the above “another synchronization signal” is the synchronization signal transmitted by the third terminal 20E.

When detecting the another synchronization signal, the controller 206E sends a notification of a presence of the one terminal 20E of the second terminal 20E and the third terminal 20E having a higher priority to the other one terminal 20E of the second terminal 20E and the third terminal 20E having a lower priority. In this example, the controller 206E sends the above notification based on a priority associated with the detected synchronization signal. In addition, the notification is also referred to as a report.

In this example, the above notification is sent when the first terminal 20E executes the RA procedure between the first terminal 20E and the notification destination terminal 20E. In this example, the controller 206E controls the RA signal generator 217E to execute the RA procedure between the first terminal 20E and the notification destination terminal 20E. When radio resources are allocated by the notification destination terminal 20E in response to a random access signal, the controller 206E controls the control signal generator 210 or the data signal generator 211 to send the above notification by using the allocated radio resources.

Further, when receiving the above notification from the terminal 20E different from the local terminal 20E in the second operation mode, the controller 206E stops transmitting synchronization signals at the local terminal 20E.

Meanwhile, when not receiving the above notification from the terminal 20E different from the local terminal 20E in the second operation mode, the controller 206E continues transmitting synchronization signals at the local terminal 20E.

In addition, when receiving the above notification from the terminal 20E different from the local terminal 20E in the second operation mode, the controller 206E may continue transmitting synchronization signals, and decrease synchronization signal transmission power.

(Operation)

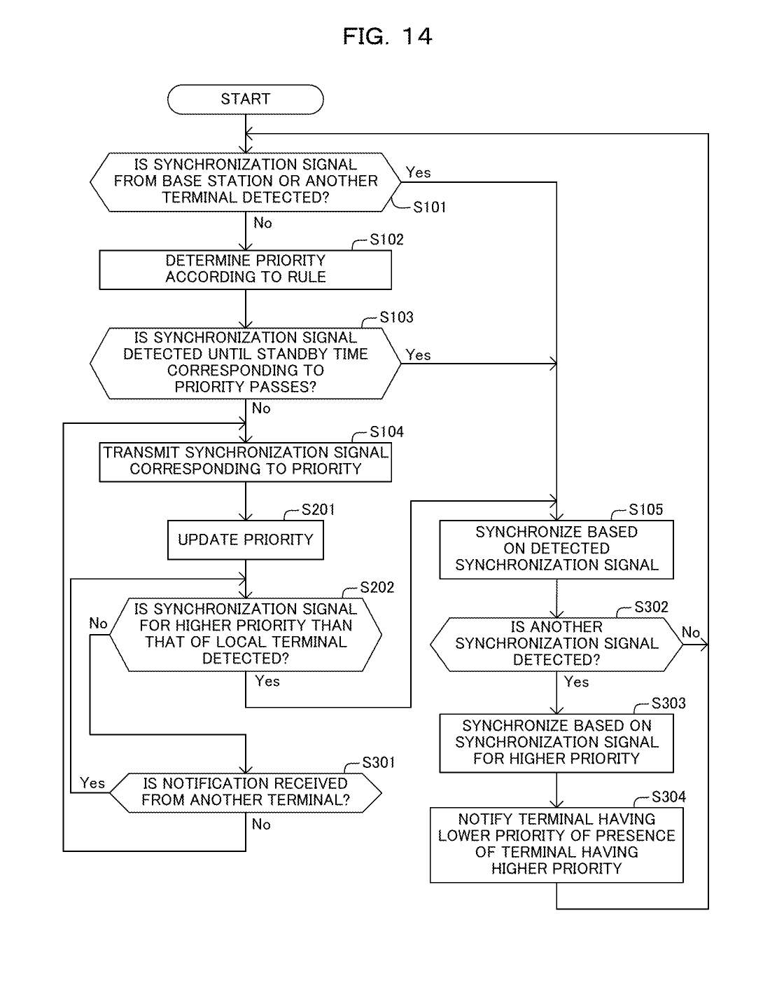

Next, an operation of the first terminal 20E according to Modified Example 1 will be described with reference to FIG. 14.

The first terminal 20E according to Modified Example 1 executes a process in FIG. 14 instead of the process in FIG. 12. The process in FIG. 14 is a process additionally including step S301 in FIG. 14 in a No route in step S202 in FIG. 12, and additionally including steps S302 to S304 in FIG. 14 subsequent to step S105 in FIG. 12.

The first terminal 20E determines that a synchronization signal associated with a higher priority than the priority of the local terminal 20E has not been detected (the No route in step S202 in FIG. 14), and then determines whether or not a notification has been received from the other terminal 20E (step S301 in FIG. 14).

First, a case where the first terminal 20E does not receive a notification from the other terminal 20E will be assumed. In this case, the first terminal 20E determines “No”, and returns to step S104 in FIG. 14. In this case, the first terminal 20E continues transmitting synchronization signals.

Next, a case where the first terminal 20E receives a notification from the other terminal 20E will be assumed. In this case, the first terminal 20E determines “Yes”, and returns to step S202 in FIG. 14. Hence, in this case, the first terminal 20E does not execute step S104 and therefore does not transmit synchronization signals. Accordingly, in this case, the first terminal 20E stops transmitting synchronization signals.

Further, a case where a synchronization signal from the second terminal 20E having a higher priority than the priority of the local terminal 20E has been detected will be assumed. In this case, the first terminal 20E determines “Yes” in step S202 in FIG. 14, and moves to step S105 in FIG. 14.

Then, the first terminal 20E synchronizes a communication timing with that of the second terminal 20E which has transmitted the synchronization signal, based on the detected synchronization signal (step S105 in FIG. 14). Next, the first terminal 20E determines whether or not another synchronization signal (a synchronization signal from the third terminal 20E in this example) is detected (step S302 in FIG. 14).

When not detecting the another synchronization signal, the first terminal 20E determines “No”, and returns to step S101 in FIG. 14. Meanwhile, when detecting the another synchronization signal, the first terminal 20E determines “Yes”, and moves to step S303 in FIG. 14.

Then, the first terminal 20E synchronizes a communication timing with that of the one terminal 20E of the second terminal 20E and the third terminal 20E which has a higher priority and has transmitted a synchronization signal, based on the synchronization signal from the one terminal 20E (step S303 in FIG. 14).

Next, the first terminal 20E sends a notification of a presence of the one terminal 20E of the second terminal 20E and the third terminal 20E having a higher priority to the other one terminal 20E of the second terminal 20E and the third terminal 20E having a lower priority (step S304 in FIG. 14). Subsequently, the first terminal 20E returns to step S101 in FIG. 14.

When, for example, the priority of the second terminal 20E is higher than the priority of the third terminal 20E, the first terminal 20E synchronizes a communication timing with that of the second terminal 20E based on the synchronization signal from the second terminal 20E in step S303. Further, in this case, the first terminal 20E notifies the third terminal 20E of the presence of the second terminal 20E in step S304. Thus, the third terminal 20E stops transmitting synchronization signals at the third terminal 20E. Consequently, it is possible to reduce in the first terminal 20E an interference of synchronization signals from the third terminal 20E with signals from the second terminal 20E.

By contrast with this, when, for example, the priority of the third terminal 20E is higher than the priority of the second terminal 20E, the first terminal 20E synchronizes a communication timing with that of the third terminal 20E based on the synchronization signal from the third terminal 20E in step S303. Further, in this case, the first terminal 20E notifies the second terminal 20E of the presence of the third terminal 20E in step S304. Thus, in this case, the second terminal 20E stops transmitting synchronization signals at the second terminal 20E. Consequently, it is possible to reduce in the first terminal 20E an interference of synchronization signals from the second terminal 20E with signals from the third terminal 20E.

As described above, in response to reception of synchronization signals from each of the second and third terminals 20E of the different priorities, the first terminal 20E according to Modified Example 1 sends a notification of the presence of the other one terminal 20E to the one terminal 20E of the second and third terminals 20E having a lower priority.

Consequently, even when the one terminal 20E fails to receive a synchronization signal from the other terminal 20E, the one terminal 20E can recognize the presence of the other terminal 20E.

In addition, the terminal 20E needs not to update the priority. Further, the terminal 20E may use a priority received from the base station 10 as a priority of the local terminal 20E without determining the priority of the local terminal 20E.

Furthermore, the terminal 20E may continue transmitting synchronization signals when receiving synchronization signals from the other terminals 20E having higher priorities than the priority of the local terminal 20E in the second operation mode.

### Modified Example 2 of Second Embodiment

Next, a wireless communication system according to Modified Example 2 of the second embodiment of the present invention will be described. The wireless communication system according to Modified Example 2 of the second embodiment differs from the wireless communication system according to the second embodiment in transmitting synchronization signals when each terminal receives a synchronization signal from each of a plurality of terminals in the first operation mode. Such a difference will be mainly described below. In addition, in description of Modified Example 2 of the second embodiment, components assigned the same reference numerals as those used in the second embodiment will be identical or substantially same components.

(Function)

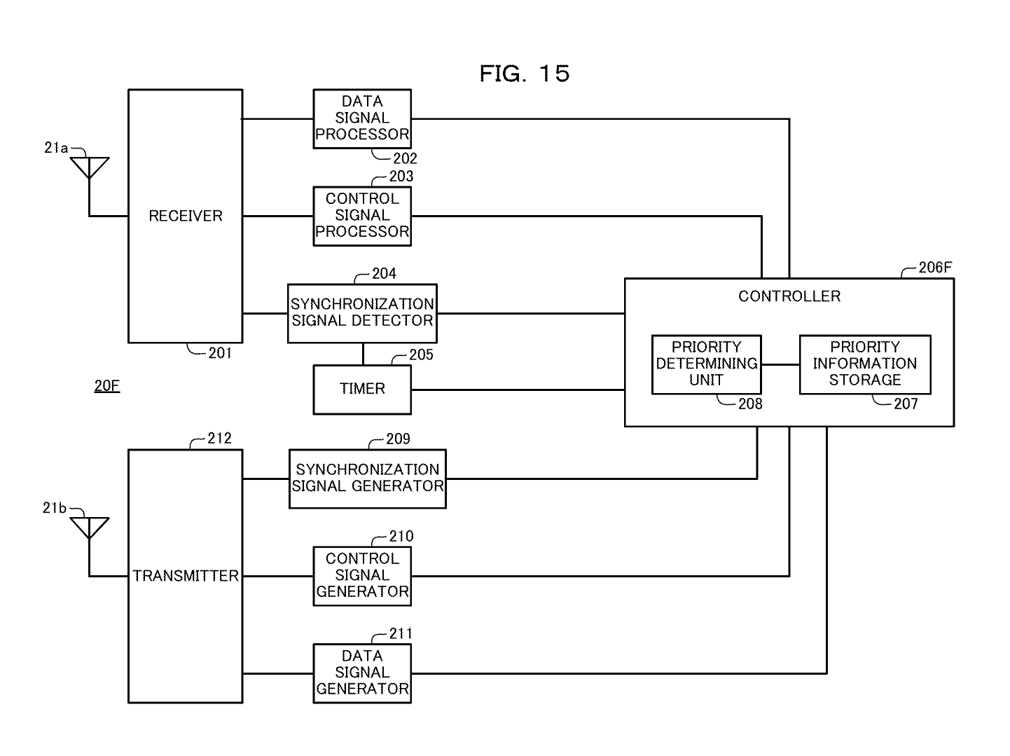

As illustrated in FIG. 15, a terminal 20F according to Modified Example 2 functionally includes a controller 206F instead of the controller 206D in FIG. 11.

In this regard, for ease of description, the terminal 20F of interest will be referred to as the first terminal 20F or the local terminal 20F, the terminal 20F different from the first terminal 20F will be referred to as the second terminal 20F, and the terminal 20F different from the first terminal 20F and the second terminal 20F will be referred to as the third terminal 20F.

The controller 206F includes the same functions as those of the controller 206D except that the first terminal 20F transmits synchronization signals when receiving a synchronization signal from each of the second terminal 20F and the third terminal 20F in the first operation mode.

In this example, the controller 206F determines whether or not another synchronization signal has been detected, based on a detection result of the synchronization signal detector 204 in the first operation mode of the local terminal 20F.

In this regard, the another synchronization signal is a synchronization signal transmitted by the third terminal 20F different from the second terminal 20F which has transmitted a synchronization signal based on which the first terminal 20F determines to operate in the first operation mode. For example, a case where the first terminal 20F receives a synchronization signal from the second terminal 20F different from the local terminal 20F, and determines to operate in the first operation mode in response to reception of the synchronization signal will be assumed. In this case, a case where the first terminal 20F receives a synchronization signal from the third terminal 20F, too, will be assumed. In this case, the above “another synchronization signal” is the synchronization signal transmitted by the third terminal 20F.

When detecting the another synchronization signal, the controller 206F performs control to synchronize a communication timing with that of the one terminal 20F of the second terminal 20F and the third terminal 20F having a higher priority. Further, in this case, the controller 206F controls the synchronization signal generator 209 to transmit synchronization signals.

In this example, the controller 206F controls the synchronization signal generator 209 such that a synchronization signal transmission timing is a timing based on a timing at which a synchronization signal is received from the parent terminal 20F. In this example, the parent terminal 20F is the one terminal 20F of the second terminal 20F and the third terminal 20F having a higher priority. For example, the timing based on the timing at which the synchronization signal is received from the parent terminal 20F is a timing at which the synchronization signal is received from the parent terminal 20F or a timing which is different by a certain time from the timing at which the synchronization signal is received from the parent terminal 20F.

Thus, the controller 206F transmits synchronization signals in response to reception of synchronization signals from each of the second terminal 20F and the third terminal 20F.

Consequently, even when the one terminal 20F of the second terminal 20F and the third terminal 20F fails to receive a synchronization signal from the other one terminal 20F of the second terminal 20F and the third terminal 20F, the one terminal 20F can receive a synchronization signal from the first terminal 20F.

(Function)

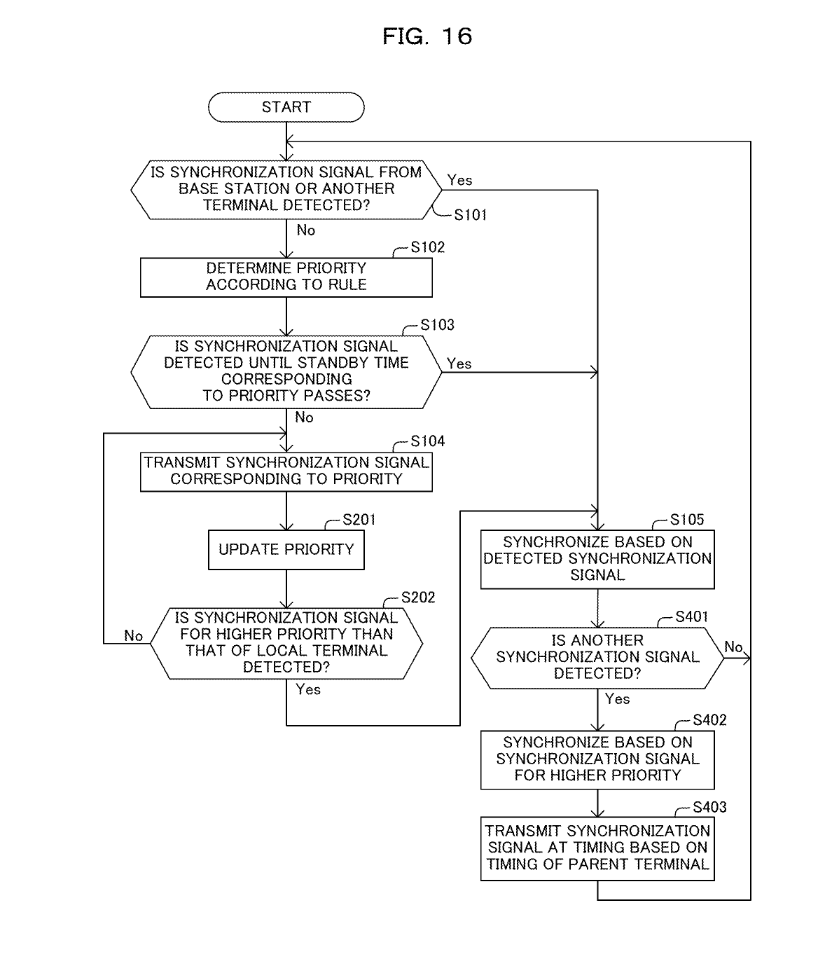

Next, an operation of the first terminal 20F according to Modified Example 2 will be described with reference to FIG. 16.

The first terminal 20F according to Modified Example 2 executes a process in FIG. 16 instead of the process in FIG. 12. The process in FIG. 16 additionally includes steps S401 to S403 in FIG. 16 subsequent to step S105 in FIG. 12.

Hereinafter, a case where the first terminal 20F detects a synchronization signal from the second terminal 20F having a higher priority than the priority of the local terminal 20F in step S202 in FIG. 16 will be assumed. In this case, the first terminal 20F determines “Yes”, and moves to step S105 to synchronize a communication timing with that of the second terminal 20F which has transmitted the synchronization signal, based on the detected synchronization signal (step S105 in FIG. 16).

Next, the first terminal 20F determines whether or not another synchronization signal (a synchronization signal from the third terminal 20F in this example) is detected (step S401 in FIG. 16).

When not detecting the another synchronization signal, the first terminal 20F determines “No”, and returns to step S101 in FIG. 16. Meanwhile, when detecting the another synchronization signal, the first terminal 20F determines “Yes”, and moves to step S402 in FIG. 16.

Then, the first terminal 20F synchronizes a communication timing with that of the one terminal 20F of the second terminal 20F and the third terminal 20F which has a higher priority and has transmitted a synchronization signal based on the synchronization signal from the one terminal 20F (step S402 in FIG. 16).

Next, the first terminal 20F transmits a synchronization signal at a timing based on a timing at which a synchronization signal is received from the parent terminal 20F which is synchronized with the communication timings in above step S402 (step S403 in FIG. 16). Subsequently, the first terminal 20F returns to step S101 in FIG. 16.

When, for example, the priority of the second terminal 20F is higher than the priority of the third terminal 20F, the first terminal 20F synchronizes a communication timing with that of the second terminal 20F based on the synchronization signal from the second terminal 20F in step S402. Further, in this case, the first terminal 20F transmits a synchronization signal at a timing based on the timing at which the synchronization signal is received from the second terminal 20F in step S403.

In this case, a case where the priority of the first terminal 20F is higher than the priority of the third terminal 20F will be assumed. In this case, the third terminal 20F switches an operation mode from the second operation mode to the first operation mode in response to reception of the synchronization signal from the first terminal 20F. Thus, the third terminal 20F stops transmitting synchronization signals at the third terminal 20F. Consequently, it is possible to reduce in the first terminal 20F an interference of synchronization signals from the third terminal 20F with signals from the second terminal 20F.

As described above, the first terminal 20F according to Modified Example 2 transmits synchronization signals in response to reception of synchronization signals from each of the second terminal 20F and the third terminal 20F.

Consequently, even when the one terminal 20F of the second and third terminals 20F fails to receive a synchronization signal from the other one terminal 20F of the second and third terminals 20F, the one terminal 20F can receive a synchronization signal from the first terminal 20F.

In addition, the terminal 20F needs not to update a priority. Further, the terminal 20F may use a priority received from the base station 10 as the priority of the local terminal 20F without determining the priority of the local terminal 20F.

Furthermore, the terminal 20F may continue transmitting synchronization signals when receiving synchronization signals from the other terminals 20F having higher priorities than the priority of the local terminal 20F in the second operation mode.

### Third Embodiment

Next, a wireless communication system according to the third embodiment of the present invention will be described. The wireless communication system according to the third embodiment differs from the wireless communication system according to the second embodiment in notifying one terminal of a difference between timings at which synchronization signals are received from a plurality of terminals. Such a difference will be mainly described below. In addition, in description of the third embodiment, components assigned the same reference numerals as those used in the second embodiment will be identical or substantially same components.

(Function)

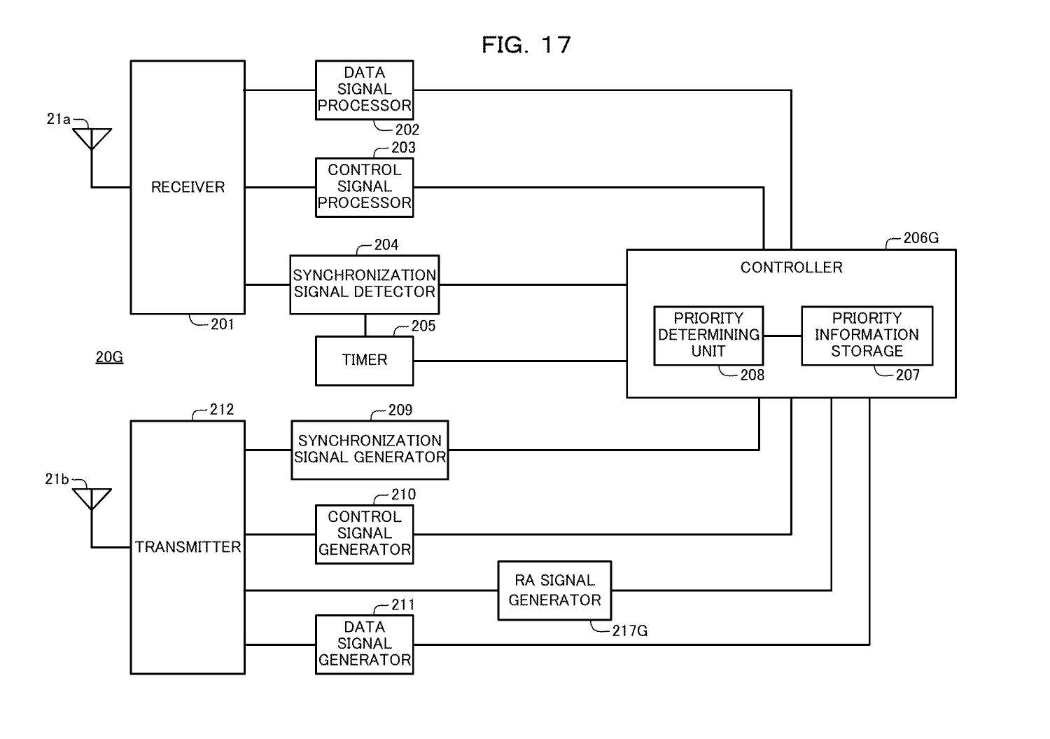

As illustrated in FIG. 17, a terminal 20G according to the third embodiment functionally includes an RA signal generator 217G in addition functions of the terminal 20D in FIG. 11. The RA is an abbreviation of a Random Access.

The RA signal generator 217G generates an RA signal for executing an RA procedure. For example, the RA procedure may be a competition-based or non-competition-based RA procedure. The RA signal generator 217G outputs a generated RA signal to transmit the RA signal by using predetermined radio resources under control of a controller 206G described below.

Further, the terminal 20G according to the third embodiment functionally includes the controller 206G instead of the controller 206D in FIG. 11.

In this regard, for ease of description, the terminal 20G of interest will be referred to as the first terminal 20G or the local terminal 20G, the terminal 20G different from the first terminal 20G will be referred to as the second terminal 20G, and the terminal 20G different from the first terminal 20G and the second terminal 20G will be referred to as the third terminal 20G.

The controller 206G includes the same functions as those of the controller 206D except for first and second differences. The first difference is that, when receiving synchronization signals from each of the second and third terminals 20G, one of the second terminals 20G and the third terminals 20G is notified of a difference between a timing at which a synchronization signal is received from the second terminal 20G and a timing at which a synchronization signal is received from the third terminal 20G. The second difference is that a synchronization signal transmission timing at the local terminal 20G is adjusted based on a notification from the terminal 20G different from the local terminal 20G.

In the present embodiment, the controller 206G determines whether or not another synchronization signal has been detected, based on a detection result of the synchronization signal detector 204 in the first operation mode.

In this regard, the another synchronization signal is a synchronization signal transmitted by the third terminal 20G different from the second terminal 20G which has transmitted a synchronization signal based on which the first terminal 20G determines to operate in the first operation mode. For example, a case where the first terminal 20G receives a synchronization signal from the second terminal 20G different from the local terminal 20G, and determines to operate in the first operation mode in response to reception of the synchronization signal will be assumed. In this case, a case where the first terminal 20G receives a synchronization signal from the third terminals 20G, too, will be assumed. In this case, the above “another synchronization signal” is a synchronization signal transmitted by the third terminal 20G.

When detecting the another synchronization signal, the controller 206G performs control to synchronize a communication timing with that of the one terminal 20G of the second terminal 20G and the third terminal 20G having a higher priority.

Further, in this case, the controller 206G sends to the other one terminal 20G of the second terminal 20G and the third terminal 20G having a lower priority a notification of a difference between a timing at which a synchronization signal is received from the second terminal 20G and a timing at which a synchronization signal is received from the third terminal 20G. In the present embodiment, the controller 206G determines the notification destination terminal 20G based on a priority associated with the detected synchronization signal. In addition, the difference between a timing at which a synchronization signal is received from the second terminal 20G and a timing at which a synchronization signal is received from the third terminal 20G is also referred to as a time difference between synchronization signals.

In the present embodiment, the above notification is sent when the first terminal 20G executes the RA procedure between the first terminal 20G and the notification destination terminal 20G. In the present embodiment, the controller 206G controls the RA signal generator 217G to execute the RA procedure between the first terminal 20G and the notification destination terminal 20G. When radio resources are allocated by the notification destination terminal 20G, the controller 206G controls the control signal generator 210 or the data signal generator 211 to send the notification by using allocated radio resources.

Further, the controller 206G adjusts a synchronization signal transmission timing at the local terminal 20G when receiving the above notification from the terminal 20G different from the local terminal 20G in the second operation mode.

In the present embodiment, the controller 206G adjusts the synchronization signal transmission timing at the local terminal 20G such that synchronization transmission timings synchronize between terminals 20G which are transmission sources of the synchronization signals based on which this notification is sent synchronize based on the above notification.

Meanwhile, the controller 206G does not adjust a synchronization signal transmission timing at the local terminal 20G when not receiving the above notification from the terminal 20G different from the local terminal 20G in the second operation mode.

(Operation)

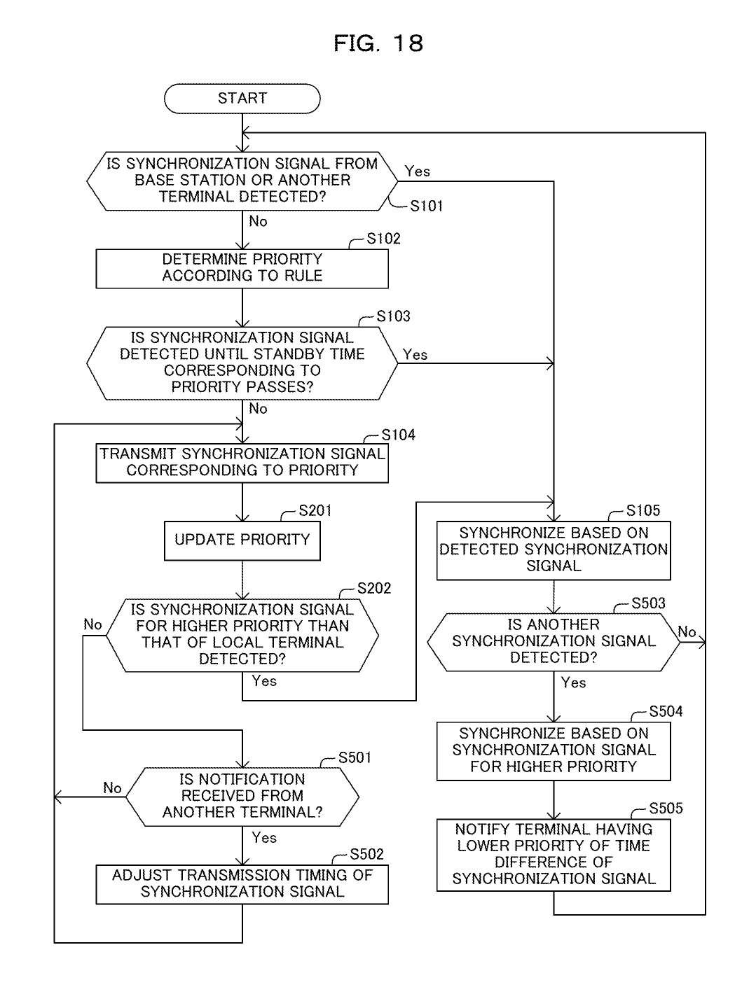

Next, an operation of the first terminal 20G according to the third embodiment will be described with reference to FIG. 18.

The first terminal 20G according to the third embodiment executes a process in FIG. 18 instead of the process in FIG. 12. The process in FIG. 18 is a process additionally including steps S501 and S502 in FIG. 18 in a No route in step S202 in FIG. 12, and additionally including steps S503 to S505 in FIG. 18 subsequent to step S105 in FIG. 12.

The first terminal 20G determines that a synchronization signal associated with a higher priority than a priority of a local terminal 20G has not been detected (the No route in step S202 in FIG. 18), and then determines whether or not a notification from the another terminal 20G has been received (step S501 in FIG. 18).

First, a case where the first terminal 20G has not received the notification from the another terminal 20G will be assumed. In this case, the first terminal 20G determines “No”, and returns to step S104 in FIG. 18.

Next, a case where the first terminal 20G receives the notification from the another terminal 20G will be assumed. In this case, the first terminal 20G determines “Yes”, and adjusts a synchronization signal transmission timing at the local terminal 20G based on the notification (step S502 in FIG. 18). Further, the first terminal 20G returns to step S104 in FIG. 18.

Hereinafter, a case where a synchronization signal from the second terminal 20G having a higher priority than the priority of the local terminal 20G has been detected will be assumed. In this case, the first terminal 20G determines “Yes” in step S202 in FIG. 18, and moves to step S105 in FIG. 18.

Then, the first terminal 20G synchronizes a communication timing with that of the second terminal 20G which has transmitted the synchronization signal, based on the detected synchronization signal (step S105 in FIG. 18). Next, the first terminal 20G determines whether or not another synchronization signal (a synchronization signal from the third terminal 20G in the present embodiment) is detected (step S503 in FIG. 18).

When not detecting the another synchronization signal, the first terminal 20G determines “No”, and returns to step S101 in FIG. 18. Meanwhile, when detecting the another synchronization signal, the first terminal 20G determines “Yes”, and moves to step S504 in FIG. 18.

Then, the first terminal 20G synchronizes a communication timing with that of the one terminal 20G of the second terminal 20G and the third terminal 20G which has a higher priority and has transmitted a synchronization signal, based on the synchronization signal from the one terminal 20G (step S504 in FIG. 18).

Next, the first terminal 20G sends to the other one terminal 20G of the second and third terminals 20G having a lower priority a notification of a difference between a timing at which a synchronization signal is received from the second terminal 20G and a timing at which a synchronization signal is received from the third terminal 20G (step S505 in FIG. 18). Subsequently, the first terminal 20G returns to step S101 in FIG. 18.

When, for example, the priority of the second terminal 20G is higher than the priority of the third terminal 20G, the first terminal 20G synchronizes a communication timing with that of the second terminal 20G, based on the synchronization signal from the second terminal 20G in step S504. Further, in this case, the first terminal 20G notifies the third terminal 20G of a time difference between the synchronization signals in step S505.

Thus, the third terminal 20G synchronizes a synchronization signal transmission timing at the third terminal 20G with a synchronization signal transmission timing at the second terminal 20G based on the notification. Consequently, the first terminal 20G can prevent an interference of signals from the third terminal 20G with signals received from the second terminal 20G. Hence, it is possible to increase quality of communication between the terminals 20G. Consequently, it is possible to effectively use radio resources.

By contrast with this, when, for example, the priority of the third terminal 20G is higher than the priority of the second terminal 20G, the first terminal 20G synchronizes a communication timing with that of the third terminal 20G, based on a synchronization signal from the third terminal 20G in step S504. Further, in this case, the first terminal 20G notifies the second terminal 20G of the time difference between the synchronization signals in step S505.

Thus, the second terminal 20G synchronizes a synchronization signal transmission timing at the second terminal 20G with a synchronization signal transmission timing at the third terminal 20G based on the notification. Consequently, the first terminal 20G can prevent an interference of signals from the second terminal 20G with signals received from the third terminal 20G. Consequently, it is possible to increase quality of communication between the terminals 20G. Hence, it is possible to effectively use radio resources.

As described above, the first terminal 20G according to the third embodiment notifies the one terminal 20G of the second and third terminals 20G of a time difference between synchronization signals in response to reception of the synchronization signals from each of the second and third terminals 20G.

Consequently, it is possible to synchronize synchronization signal transmission timings between the second and third terminals 20G. Thus, the first terminal 20G can prevent an interference of signals from one of the second and third terminals 20G with signals received from the other one of the second and third terminals 20G. Consequently, it is possible to increase quality of communication between the terminals 20G. Hence, it is possible to effectively use radio resources.

Further, the first terminal 20G according to the third embodiment sends a notification of a time difference between synchronization signals to the one terminal 20G of the second and third terminals 20G having a lower priority related to transmission of a synchronization signal. Furthermore, the other one terminal 20G of the second and third terminals 20G synchronizes a timing at which a synchronization signal is to be transmitted with that of the one terminal 20G based on the notification.

The terminal 20G having a higher priority tends to have a larger number of cluster members connecting to the terminal 20G. Consequently, it is possible to increase a probability that it is possible to reduce radio resources used to control synchronization signal transmission timings compared to a case where the terminal 20G of a relatively high priority synchronizes a timing at which a synchronization signal is to be transmitted with that of the terminal 20G of a relatively low priority.

In addition, the terminal 20G needs not to update the priority. Further, the terminal 20G may use a priority received from the base station 10 as the priority of the local terminal 20G without determining the priority of the local terminal 20G. Furthermore, the terminal 20G may continue transmitting synchronization signals when receiving synchronization signals from the other terminals 20G having higher priorities than the priority of the local terminal 20G in the second operation mode.

Still further, the first terminal 20G may notify both of the second and third terminals 20G of a time difference between synchronization signals. In this case, the notification may include an identifier for identifying a wireless area or the terminal 20G and a priority associated with the identifier. In this case, the second terminal 20G may adjust a synchronization signal transmission timing when the priority of the local terminal 20G is lower than the priority of the third terminal 20G. Similarly, the third terminal 20G may adjust a synchronization signal transmission timing when the priority of the local terminal 20G is lower than the priority of the second terminal 20G.

Further, when receiving synchronization signals from each of the second and third terminals 20G, the first terminal 20G may send a notification of a time difference between synchronization signals if a notification condition described below holds, and needs not to send a notification of the time difference between synchronization signals if the notification condition does not hold. Furthermore, when receiving synchronization signals from each of the second and third terminals 20G, the first terminal 20G may send a notification of a stop instruction to the one terminal 20G of the second and third terminals 20G having a lower priority if the notification condition does not hold. In the present embodiment, the stop instruction is information for instructing to stop transmitting synchronization signals. Hence, the terminal 20G notified of the stop instruction stops transmitting synchronization signals.

The notification condition includes, for example, one of the following.

(1) Both of the priority of the second terminal 20G and the priority of the third terminal 20G are higher than a certain reference priority.

(2) A difference between the priority of the second terminal 20G and the priority of the third terminal 20G is smaller than a certain reference difference.

(3) Both of the number of cluster members whose connection destinations are the second terminal 20G and the number of cluster members whose connection destinations are the third terminal 20G are larger than a certain reference number.

(4) A difference between the number of cluster members whose connection destinations are the second terminal 20G and the number of cluster members whose connection destinations are the third terminal 20G is smaller than a certain reference difference.

(5) Both of a time from starting transmitting synchronization signals by the second terminal 20G and a time from starting transmitting synchronization signals by the third terminal 20G are longer than a certain reference time.

(6) A difference between a time from starting transmitting synchronization signals by the second terminal 20G and a time from starting transmitting synchronization signals by the third terminal 20G is smaller than a certain reference difference.

Further, a notification destination of a time difference between synchronization signals may be the one terminal 20G of the second and third terminals 20G whose a number of the connecting cluster members 20G is smaller. Furthermore, a notification destination of a time difference between synchronization signals may be the one terminal 20G of the second and third terminals 20G whose a time from starting transmitting synchronization signals is shorter.

### Fourth Embodiment

Next, a wireless communication system according to the fourth embodiment of the present invention will be described. The wireless communication system according to the fourth embodiment differs from the wireless communication system according to the second embodiment in instructing another terminal to switch to a cluster head before a terminal switches from a cluster head to a cluster member. Such a difference will be mainly described below. In addition, in description of the fourth embodiment, components assigned the same reference numerals as those used in the second embodiment will be identical or substantially same components.

(Function)

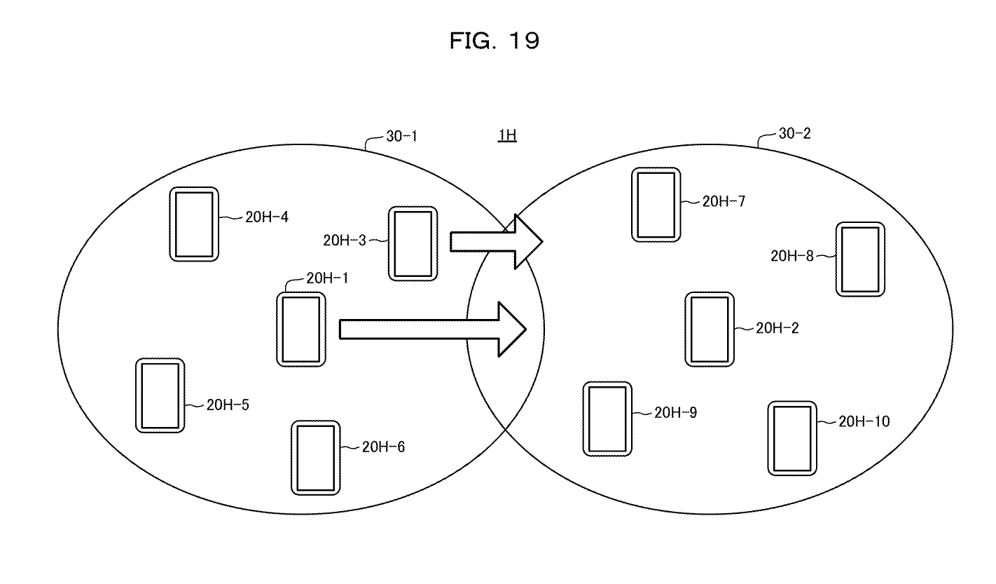

As illustrated in FIG. 19, a wireless communication system 1H according to the fourth embodiment includes terminals 20H-1 to 20H-10 instead of terminals 20-1 to 20-10 illustrated in FIG. 1.

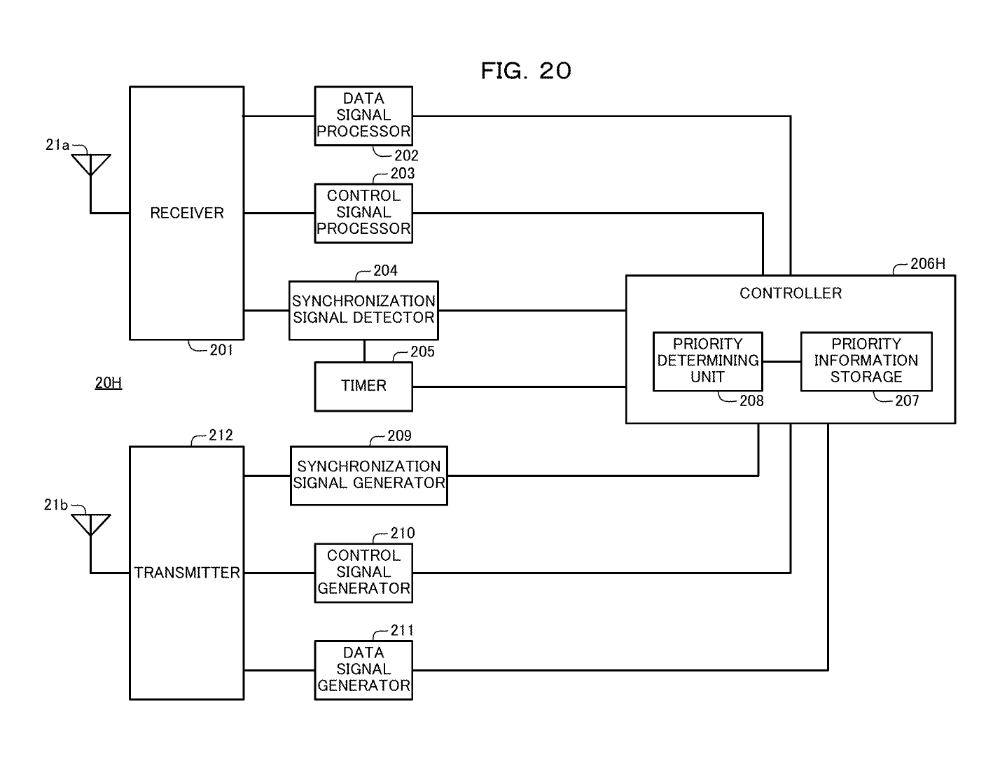

As illustrated in FIG. 20, a terminal 20H according to the fourth embodiment functionally includes a controller 206H instead of the controller 206D in FIG. 11. The controller 206H has the same functions as those of the controller 206D except for first and second differences.

The first difference is that the controller 206H controls the control signal generator 210 to transmit a head switch instruction when an operation mode of the terminal 20H switches from the second operation mode to the first operation mode.

As described above, when an operation mode of the terminal 20H is the second operation mode, a communication state of the terminal 20H is the third communication state where the terminal 20H is used as a cluster head. Further, when the operation mode of the terminal 20H is the first operation mode, the communication state of the terminal 20H is one of the second communication state where the terminal 20H is used as a cluster member, and the first communication state where the terminal 20H communicates with the base station 10.

That the terminal 20H is used as a cluster head may represent that the terminal 20H is a cluster head. Further, that the terminal 20H is used as a cluster member may represent that the terminal 20H is a cluster member.

In the present embodiment, it is assumed that, for ease of description, when the operation mode of the terminal 20H is the first operation mode, the communication state of the terminal 20H is the second communication state. Hence, in the present embodiment, that the operation mode of the terminal 20H switches from the second operation mode to the first operation mode represents that the terminal 20H is changed from a cluster head to a cluster member. The change from a cluster head to a cluster member may represent switching from a cluster head to a cluster member.

In the present embodiment, a case where, as illustrated in FIG. 19, the terminal 20H-1 which is a cluster head comes close to the terminal 20H-2 which is a cluster head to receive a synchronization signal transmitted by the terminal 20H-2 will be assumed. In addition, in this case, the terminal 20H-2, too, receives a synchronization signal transmitted by the terminal 20H-1 likewise.

In the present embodiment, the head switch instruction is information for instructing to switch a connection destination cluster head. The head switch instruction is an example of information indicating integration of a plurality of clusters. In the present embodiment, the head switch instruction is included in a control signal.

By transmitting a head switch instruction by the controller 206H, the cluster head 20H sends a notification of integration of a plurality of clusters to cluster members which are the other terminals 20H forming a cluster together with the cluster head 20H. In this regard, the cluster includes a plurality of terminals 20H, and is formed to enable direct communication between the plurality of terminals 20H in response to synchronization signals to be transmitted by the cluster head 20H.

The second difference is that, when the terminal 20H is used as a cluster member and receives the head switch instruction, the controller 206H controls the synchronization signal detector 204 to perform a process of detecting a synchronization signal transmitted from the terminal 20H different from a connection destination cluster head.

Consequently, the cluster members 20H which form a cluster together with the cluster head 20H can quickly detect synchronization signals to be transmitted by the other cluster heads 20H. As a result, the cluster members 20H can quickly switch the cluster head 20H which is to be a destination of connection.

Similar to the controller 206D in FIG. 11, the controller 206H changes the local terminal 20H from a cluster head to a cluster member when a priority associated with the detected synchronization signal is higher than a priority of the local terminal 20H. Hence, in this case, the controller 206H stops transmitting synchronization signals at the local terminal 20H.

Meanwhile, when the priority associated with the detected synchronization signal is lower than the priority of the local terminal 20H, the controller 206H maintains a state where the local terminal 20H is used as a cluster head similar to the controller 206D in FIG. 11. Hence, in this case, the controller 206H continues transmitting synchronization signals at the local terminal 20H.

That the cluster head 20H receives synchronization signals transmitted by the other cluster heads 20H is an example where a plurality of cluster heads 20H exist at positions at which the plurality of cluster heads 20H can communicate with each other.

Hence, in the wireless communication system 1H, the first cluster head 20H among a plurality of cluster heads 20H existing at positions at which the plurality of cluster heads 20H can communicate with each other continues transmitting synchronization signals, and the second cluster head 20H stops transmitting synchronization signals. In this regard, a priority of the first cluster head 20H is higher than that of the second cluster head 20H.

Consequently, the terminal 20H having a higher priority can increase a probability that the terminal 20H is used as a cluster head. Further, it is possible to prevent synchronization signals from being unnecessarily transmitted.

In other words, the wireless communication system 1H integrates a plurality of clusters to be formed by synchronization signals to be transmitted by a plurality of cluster heads 20H existing at positions at which the plurality of cluster heads 20H communicate with each other, based on a priority of each of the plurality of cluster heads 20H.

Consequently, it is possible to reduce the number of cluster heads. Thus, it is possible to reduce radio resources used to perform communication between cluster heads and control cluster heads, for example. Further, it is possible to appropriately reflect each priority in cluster integration. In the present embodiment, the terminal 20H having a higher priority can increase a probability that the terminal 20H is continuously used as a cluster head.

In addition, the head switch instruction may include synchronization signal information related to a detected control signal. For example, the synchronization signal information may include at least one of information for identifying a synchronization signal, and information indicating a transmission timing which is a timing at which a synchronization signal is to be transmitted.

In the present embodiment, the information for identifying a synchronization signal is an identifier for identifying a Zadoff-Chu sequence. In addition, when a synchronization signal is associated with a priority, a priority may be used as information for identifying the synchronization signal. For example, the information indicating the timing at which a synchronization signal is to be transmitted may include information for identifying a subframe in which the synchronization signal is to be transmitted. Further, for example, the information indicating the timing at which a synchronization signal is to be transmitted may include information indicating a difference between a timing at which a cluster head which is not yet switched transmits a synchronization signal, and a timing at which the switched cluster head transmits a synchronization signal.

The information for identifying a synchronization signal and the information indicating a synchronization signal transmission timing are used to, for example, detect synchronization signals. Hence, the synchronization signal information is also referred to as information used to detect a synchronization signal.

In this case, the cluster member 20H having received the head switch instruction performs a process of detecting a synchronization signal transmitted by the terminal 20H different from the cluster head 20H which is a transmission source of the head switch instruction based on the synchronization signal information included in the head switch instruction.

Consequently, the cluster members 20H forming a cluster together with the cluster head 20H can quickly detect synchronization signals to be transmitted by the other cluster heads 20H. As a result, the cluster members 20H can quickly switch the cluster head 20H which is to be a destination of connection.

(Operation)

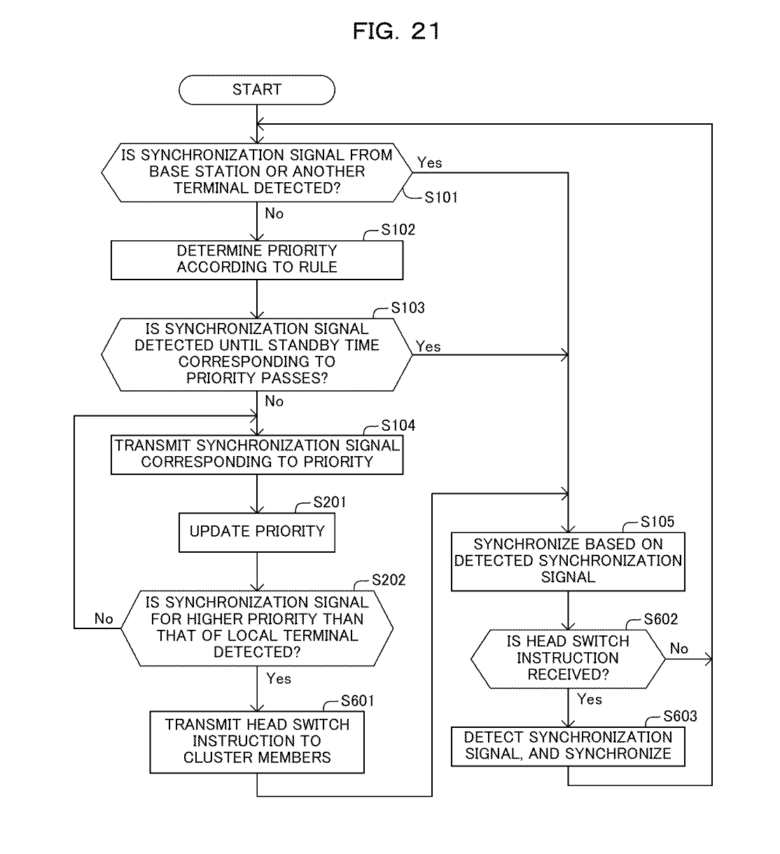

Next, an operation of the terminal 20H according to the fourth embodiment will be described with reference to FIG. 21.

The terminal 20H according to the fourth embodiment executes a process additionally including step S601 in FIG. 21 in a “Yes” route in step S202 in FIG. 12 instead of the process in FIG. 12, and additionally including steps S602 and S603 in FIG. 21 subsequent to step S105 in FIG. 12.

In the present embodiment, a case where, as illustrated in FIG. 19, in response to a synchronization signal transmitted by the terminal 20H-1 which is a cluster head, the terminals 20H-3 to 20H-6 which are cluster members form a first cluster together with the terminal 20H-1 will be assumed. Further, a case where, in response to a synchronization signal transmitted by the terminal 20H-2 which is a cluster head, the terminals 20H-7 to 20H-10 which are cluster members form a second cluster together with the terminal 20H-2 will be assumed.

In addition, a case where the cluster head 20H-1 comes close to the cluster head 20H-2 to receive a synchronization signal transmitted by the cluster head 20H-2 will be assumed. Further, in the present embodiment, a case where a priority of the cluster head 20H-1 is lower than a priority of the cluster head 20H-2 will be assumed.

First, an operation of the terminal 20H-1 will be described. In this case, when moving to step S202 in FIG. 21, the terminal 20H-1 determines “Yes”, and transmits the head switch instruction to the cluster members 20H-3 to 20H-6 (step S601 in FIG. 21).

Next, the terminal 20H-1 moves to step S105 in FIG. 21. In the present embodiment, that the terminal 20H-1 determines “Yes” in step S202 in FIG. 21 represents that the local terminal 20H-1 is changed from a cluster head to a cluster member. Hence, in this case, the terminal 20H-1 stops transmitting synchronization signals.

In this case, the terminal 20H-1 synchronizes a communication timing with that of the terminal 20H-2 which has transmitted a synchronization signal, based on the detected synchronization signal (step S105 in FIG. 21). Further, the terminal 20H-1 determines whether or not the head switch instruction has been received (step S602 in FIG. 21). At this point of time, the terminal 20H-1 determines “No”, and returns to step S101.

Next, an operation of the terminal 20H-2 will be described. The terminal 20H-2 detects a synchronization signal transmitted by the terminal 20H-1. Hence, when moving to step S202 in FIG. 21, the terminal 20H-2 determines “No”, and returns to step S104 in FIG. 21. In this case, the terminal 20H-2 maintains a state where the terminal 20H-2 is used as a cluster head. Hence, the terminal 20H-2 continues transmitting synchronization signals.

Next, an operation of the terminal 20H-3 will be described. According to the above assumption, when the terminal 20H-1 transmits a synchronization signal, the terminal 20H-3 detects the synchronization signal transmitted by the terminal 20H-1. Hence, when moving to step S101 in FIG. 21, the terminal 20H-3 determines “Yes”, and synchronizes a communication timing with that of the terminal 20H-1 which has transmitted the synchronization signal, based on the detected synchronization signal (step S105 in FIG. 21).

Then, the terminal 20H-3 determines whether or not the head switch instruction has been received (step S602 in FIG. 21). In this case, the terminal 20H-3 determines “No”, and returns to step S101.

When moving to step S602 after the terminal 20H-1 transmits the head switch instruction, the terminal 20H-3 determines “Yes”, and executes a process of detecting a synchronization signal transmitted by the terminal 20H different from the terminal 20H-1. In the present embodiment, a case where the terminal 20H-3 detects a synchronization signal transmitted by the terminal 20H-2 will be assumed.

In this case, the terminal 20H-3 synchronizes a communication timing with that of the terminal 20H-2 which has transmitted a synchronization signal, based on the detected synchronization signal (step S603 in FIG. 21). Subsequently, the terminal 20H-3 returns to step S101.

The terminals 20H-4 to 20H-6 may also operate similar to the terminal 20H-3. Thus, the first cluster and the second cluster are integrated.

In addition, when it is not possible to detect a synchronization signal transmitted from the cluster head 20H-1 which is a destination of connection in step S101 in FIG. 21, the terminal 20H-3 may perform a process of detecting synchronization signals from the other cluster heads 20H.

Consequently, the cluster member 20H-3 can quickly detect the synchronization signals transmitted by the other cluster heads 20H. As a result, the cluster member 20H-3 can quickly switch the cluster head 20H which is to be a destination of connection.

In this example, processes in steps S601 to S603 in FIG. 21 may be skipped. In this case, it is possible to reduce radio resources used to control clusters compared to a case where the head switch instruction is transmitted. Hence, it is possible to effectively use radio resources.

As described above, the wireless communication system 1H according to the fourth embodiment integrates a plurality of clusters based on a priority of each of a plurality of cluster heads 20H.

Consequently, it is possible to reduce the number of cluster heads 20H. Thus, it is possible to reduce radio resources used to, for example, perform communication between the cluster heads 20H and control the cluster head 20H. Further, it is possible to appropriately reflect each priority in cluster integration. For example, the terminal 20H having a higher priority can increase a probability that the terminal 20H is continuously used as a cluster head.

Further, in the wireless communication system 1H according to the fourth embodiment, integration of a plurality of clusters includes continuing transmitting synchronization signals by the cluster head 20H-2 having a higher priority than that of the cluster head 20H-1 among a plurality of cluster heads 20H. Furthermore, integration of a plurality of clusters includes stopping transmitting synchronization signals by the cluster head 20H-1.

Consequently, it is possible to increase a probability that the terminal 20H-2 having a higher priority can be continuously used as a cluster head. Further, it is possible to prevent synchronization signals from being unnecessarily transmitted.

In addition, in the wireless communication system 1H according to the fourth embodiment, the cluster head 20H-1 sends a notification of integration of a plurality of clusters to the cluster members 20H-3 to 20H-6 forming a cluster together with the cluster head 20H-1. Further, the cluster members 20H-3 to 20H-6 perform a process of detecting a synchronization signal transmitted from the cluster head 20H-2 in response to the notification from the cluster head 20H-1 (the head switch instruction in the present embodiment).

Consequently, the cluster members 20H-3 to 20H-6 can quickly detect a synchronization signal to be transmitted by the cluster head 20H-2. As a result, the cluster members 20H-3 to 20H-6 can quickly switch the cluster head 20H which is to be a destination of connection.

In addition, when detecting a synchronization signal associated with a priority lower than that of the local terminal 20H-2, the cluster head 20H-2 may change a synchronization signal and a synchronization signal transmission timing. In the present embodiment, the cluster head 20H-2 changes the synchronization signal transmission timing to the same timing as a timing at which the cluster head 20H-1 which is a transmission sources of the detected synchronization signal transmits the synchronization signal.

Consequently, the cluster members 20H-3 to 20H-6 forming a cluster together with the cluster head 20H-1 can detect a synchronization signal transmitted by the cluster head 20H-2 without changing a timing at which the synchronization signal is received. As a result, the cluster members 20H-3 to 20H-6 can quickly switch the cluster head 20H which is to be a destination of connection.

Further, in the present embodiment, the cluster head 20H-2 changes the synchronization signal to the same signal as the detected synchronization signal. In addition, when a synchronization signal is associated with a priority as in the present embodiment, the cluster head 20H-2 may change the synchronization signal by changing a priority to the same priority as that of the cluster head 20H-1.

Consequently, the cluster members 20H-3 to 20H-6 forming a cluster together with the cluster head 20H-1 can quickly detect a synchronization signal transmitted by the cluster head 20H-2. As a result, the cluster members 20H-3 to 20H-6 can quickly switch the cluster head 20H which is to be a destination of connection.

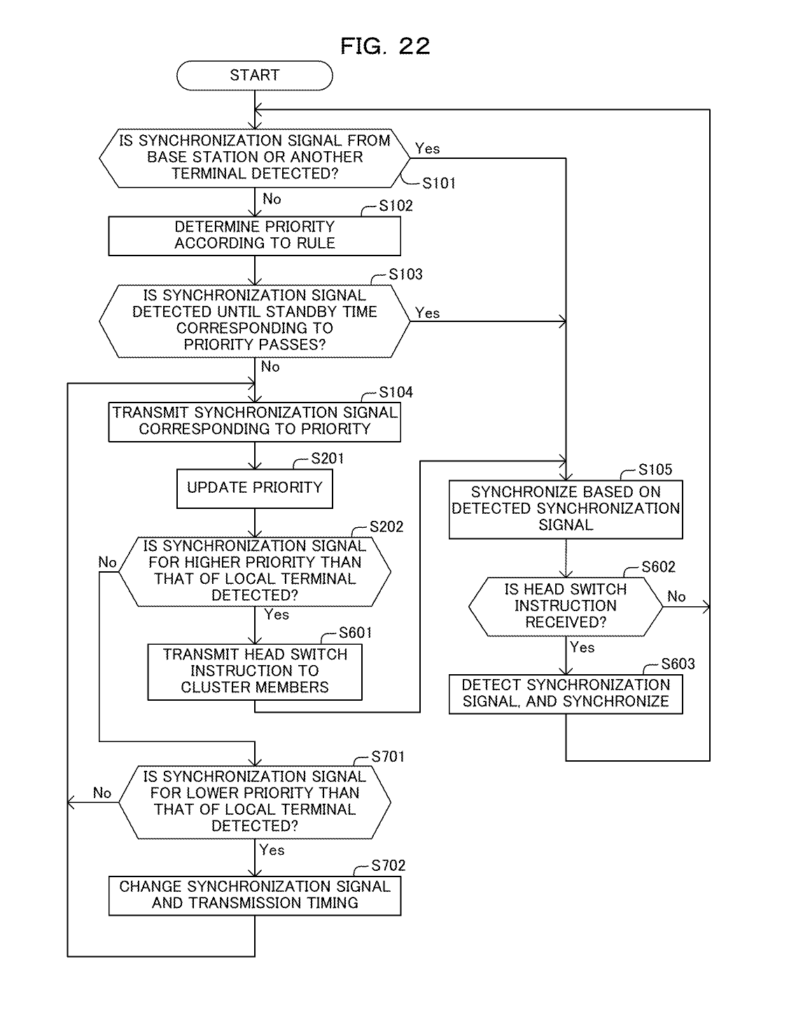

For example, as illustrated in FIG. 22, the cluster head 20H-2 may execute a process additionally including steps S701 and S702 in the No route of step S202 in FIG. 21.

When determining No in step S202 in FIG. 22, the cluster head 20H-2 determines whether or not a synchronization signal associated with a priority lower than the priority of the local terminal 20H-2 has been detected (step S701 in FIG. 22).

Hereinafter, a case where a synchronization signal associated with a priority lower than the priority of the cluster head 20H-2 and transmitted by the cluster head 20H-1 has been detected will be assumed. In this case, the cluster head 20H-2 determines “Yes”, and moves to step S702 in FIG. 22.

Then, the cluster head 20H-2 changes a synchronization signal transmission timing to the same timing as a timing at which the cluster head 20H-1 which is a transmission source of the detected synchronization signal transmits the synchronization signal. Furthermore, the cluster head 20H-2 changes the synchronization signal to the same signal as the detected synchronization signal (step S702 in FIG. 22). Subsequently, the cluster head 20H-2 returns to step S104.

Consequently, the cluster members 20H-3 to 20H-6 forming a cluster together with the cluster head 20H-1 can quickly switch the cluster head 20H which is to be a destination of connection.

In addition, in case where the synchronization signal associated with the priority lower than the priority of the cluster head 20H-2 and transmitted by the cluster head 20H-1 has not been detected, the cluster head 20H-2 determines No in step S701 in FIG. 22. Then, the cluster head 20H-2 returns to step S104 without executing a process in step S702.

Further, the cluster head 20H-2 may send a notification of synchronization signal information related to the changed synchronization signal to be transmitted by the cluster head 20H-2, to the cluster members 20H-7 to 20H-10 forming a cluster together with the cluster head 20H-2.

Consequently, even when a synchronization signal transmission timing and a synchronization signal are changed, the cluster members 20H-7 to 20H-10 can quickly detect the changed synchronization signal to be transmitted by the cluster head 20H-2.

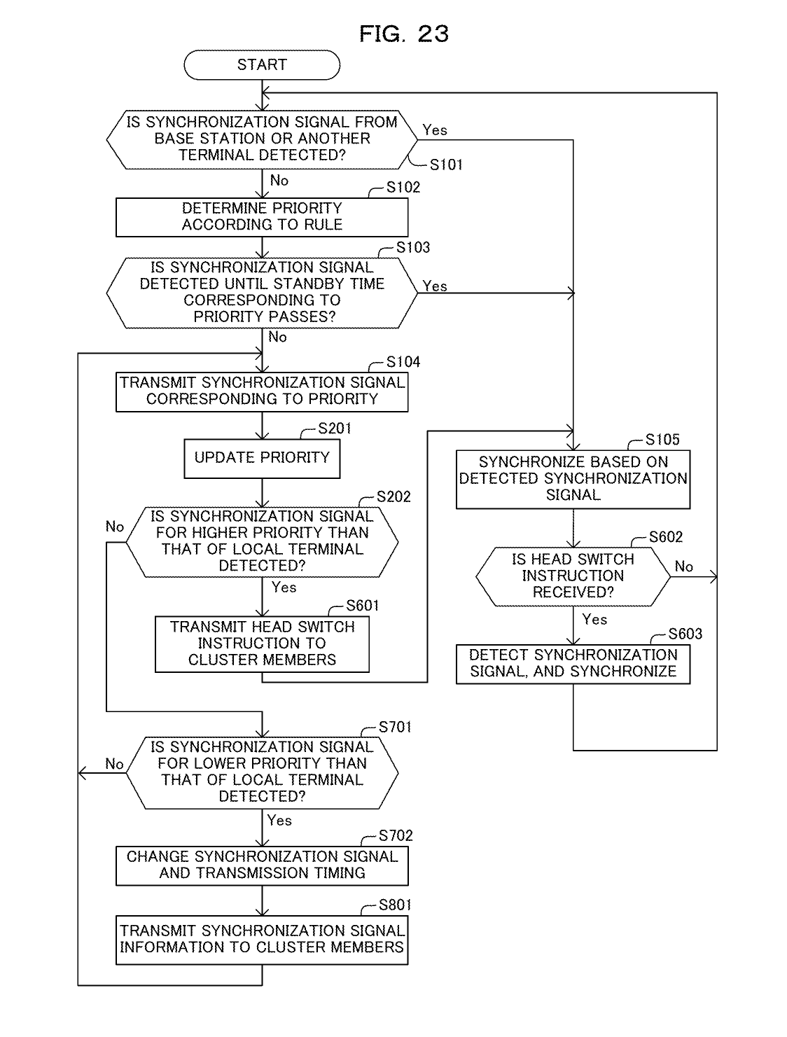

For example, the cluster head 20H-2 may execute a process additionally including step S801 subsequent to step S702 in FIG. 22 as illustrated in FIG. 23.

When changing the synchronization signal and the synchronization signal transmission timing in step S702 in FIG. 23, the cluster head 20H-2 moves to step S801 in FIG. 23.

Further, the cluster head 20H-2 transmits the synchronization signal information to the cluster members 20H-7 to 20H-10 (step S801 in FIG. 23). Each of the cluster members 20H-7 to 20H-10 detects the synchronization signal to be transmitted by the cluster head 20H-2 based on the received synchronization signal information. Subsequently, the cluster head 20H-2 returns to step S104.

Consequently, the cluster members 20H-7 to 20H-10 can quickly detect changed synchronization signal.

In addition, when a synchronization signal is not associated with a priority, and a synchronization signal from the another terminal 20H is detected, the terminal 20H may notify the other terminals 20H of priorities each other.

### Fifth Embodiment

Next, a wireless communication system according to the fifth embodiment of the present invention will be described. The wireless communication system according to the fifth embodiment differs from the wireless communication system according to the second embodiment in stopping transmitting synchronization signals at certain timings. Such a difference will be mainly described below. In addition, in description of the fifth embodiment, components assigned the same reference numerals as those used in the second embodiment will be identical or substantially same components.

(Function)

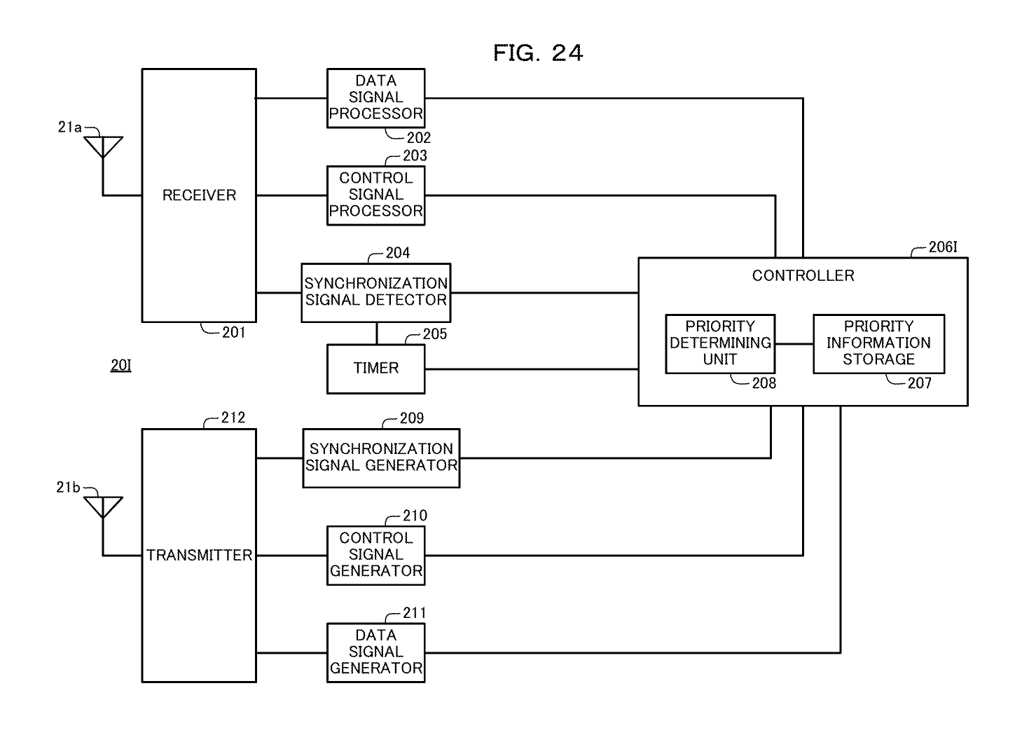

As illustrated in FIG. 24, a terminal 20I according to the fifth embodiment functionally includes a controller 206I instead of the controller 206D in FIG. 11. The controller 206I includes the same functions as those of the controller 206D except that the controller 206I controls the synchronization signal generator 209 so as not to transmit synchronization signals at part of timings of a plurality of timings determined in advance as timings to transmit synchronization signals.

In the present embodiment, synchronization signals are transmitted at a plurality of timings determined in advance in the wireless communication system. For example, a synchronization signal may be transmitted in a predetermined subframe. In the present embodiment, timings determined in advance as timings to transmit synchronization signals in the wireless communication system will be also referred to as temporary transmission timings.

The controller 206I controls the synchronization signal generator 209 so as not to transmit synchronization signals at part of a plurality of temporary transmission timings. In the present embodiment, timings of a plurality of temporary transmission timings at which synchronization signals are not transmitted will be also referred to as transmission stop timings.

The controller 206I controls the synchronization signal detector 204 to execute a process of detecting synchronization signals transmitted by the terminals 20I different from the local terminal 20I at the transmission stop timings.

Consequently, it is possible to increase a probability that synchronization signals to be transmitted from the other terminals 20I are detected.

In the present embodiment, each transmission stop timing is provided every time the temporary transmission timings come a certain number of times. For example, each transmission stop timing may be provided every time the five temporary transmission timings come. Further, each transmission stop timing may be a timing selected at random from the temporary transmission timings.

(Operation)

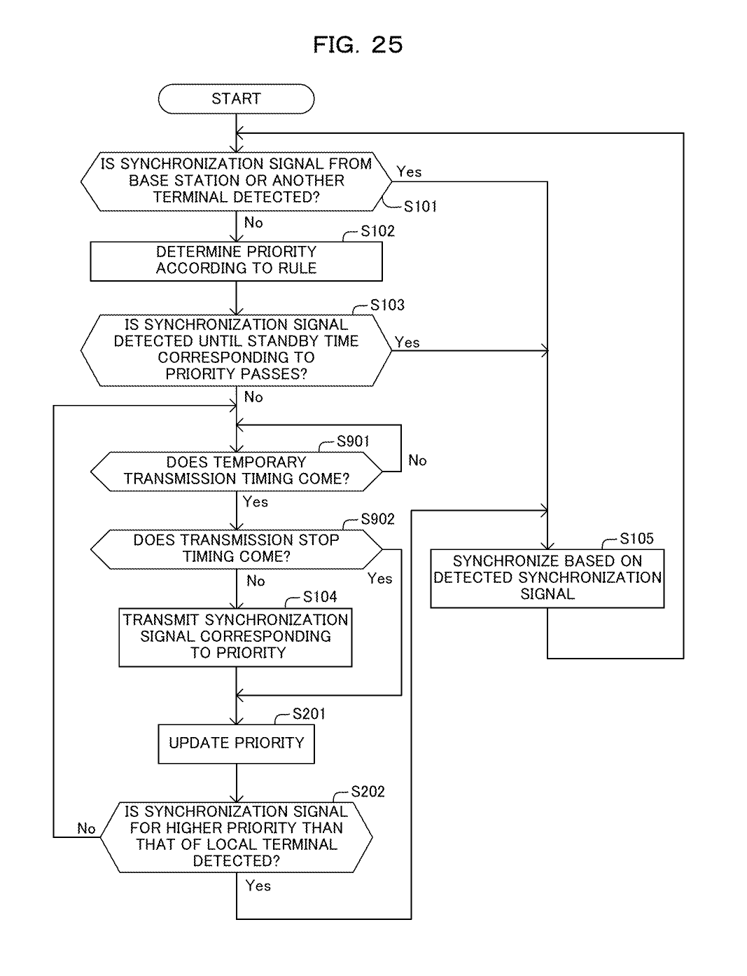

Next, an operation of the terminal 20I according to the fifth embodiment will be described with reference to FIG. 25.

The terminal 20I according to the fifth embodiment executes a process additionally including steps S901 and S902 in a No route of step S103 in FIG. 12 instead of the process in FIG. 12.

When determining No in step S103 in FIG. 25, the terminal 20I stands by until a temporary transmission timing comes (a No route in step S901 in FIG. 25). When the temporary transmission timing comes, the terminal 20I determines “Yes” in step S901, and determines whether or not the transmission stop timing has come (step S902 in FIG. 25).

In case where the transmission stop timing has not come, the terminal 20I determines No in step S902, moves to step S104 and transmits a synchronization signal corresponding to a priority (step S104 in FIG. 25). Subsequently, the terminal 20I executes the processes subsequent to step S201 similar to the terminal 20D according to the second embodiment.

Meanwhile, in case where the transmission stop timing has come, the terminal 20I determines “Yes” in step S902, and moves to step S201 without transmitting a synchronization signal. In this case, the terminal 20I executes a process of detecting a synchronization signal transmitted at the transmission stop timing by the other terminals 20I. Further, the terminal 20I executes the processes subsequent to step S201 similar to the terminal 20D according to the second embodiment.

As described above, the terminal 20I according to the fifth embodiment executes a process of detecting synchronization signals transmitted by the other terminals 20I without transmitting synchronization signals at part of timings (transmission stop timings in the present embodiment) of a plurality of temporary transmission timings.

Consequently, it is possible to increase a probability that synchronization signals to be transmitted from the other terminals 20I are detected.

In addition, the terminal 20I may skip the process in step S902.

Further, the terminal 20I according to the fifth embodiment includes the function in addition to the functions of the terminal 20D according to the second embodiment yet may include the above function in addition to those of each of the terminal 20, or 20A to 20H according to the first, third or fourth embodiment instead of the terminal 20D according to the second embodiment.

In addition, in each of the above embodiments, when a time from starting transmitting synchronization signals is longer than a certain threshold, the terminal 20 may set the priority of the local terminal 20 to a maximum value among priorities used in a wireless communication system 1.

For example, as described above, in case where a priority which is higher as a value is smaller and whose takes an integer value equal to or more than 0 is used in the wireless communication system 1, the maximum value among the priorities used in the wireless communication system 1 is 0. Hence, in this case, when a time from starting transmitting a synchronization signal is longer than a certain threshold, the terminal 20 may set the priority of the local terminal 20 to 0.

Consequently, it is possible to reduce a probability that the terminal 20 which has passed a sufficiently long time from starting transmitting the synchronization signal is changed from a cluster head to a cluster member. Thus, a terminal 20 serving as a cluster head is hardly frequently changed. Consequently, it is thus possible to reduce the number of the terminals 20 which change operation modes and the number of cluster members which change the terminal 20 which is to be a destination of connection. As a result, it is possible to reduce radio resources used by the cluster members to change the terminal 20 which is to be a destination of connection. Hence, it is possible to effectively use radio resources.

Further, in each of the above embodiments, a certain signal may be a known signal. For example, the known signal is a signal which the terminal 20 knows in advance.

Further, in each of the above embodiments, communication which a plurality of terminals 20 directly performs with each other may be referred to as direct communication or device to device (D2D) communication. Furthermore, in each of the above embodiments, communication which a plurality of terminals 20 performs via the base station 10 may be referred to as indirect communication.

In addition, in each of the above embodiments, the wireless communication system 1 may use a broadcast signal or a reference signal as a certain signal instead of a synchronization signal.

The broadcast signal indicates information broadcast to the terminal 20 positioned in a wireless area. This information is also referred to as broadcast information. For example, the broadcast information includes an MIB (Master Information Block). For example, the MIB includes a frame number (SFN: System Frame Number) of a radio frame and a system bandwidth. Further, when the terminal 20 transmits a broadcast signal, the broadcast signal may include an identifier (ID) for identifying the terminal 20.

The reference signal is used to measure at least one of reception power of radio signals, communication quality of radio signals and a state of a channel in which radio signals propagate.

It is possible to effectively use radio resources.

All examples and conditional language provided herein are intended for pedagogical purposes of aiding the reader in understanding the invention and the concepts contributed by the inventor to furthering the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A wireless communication system comprising:
a plurality of terminals; and
a wireless base station,
wherein each of the plurality of terminals determines a priority of a local terminal related to transmission of a certain signal according to a certain rule when the certain signal is not received from the wireless base station.

2. The wireless communication system according to claim 1, wherein each of the plurality of terminals starts transmitting the certain signal when the certain signal is not received until a time corresponding to the determined priority passes.

3. The wireless communication system according to claim 1, wherein the rule defines that the priority is determined based on information related to the terminal.

4. The wireless communication system according to claim 3, wherein the information related to the terminal includes at least one of a type of a user who possesses the terminal, a position of the terminal, whether the terminal is positioned indoor or outdoor, whether or not power is supplied to the terminal, a remaining amount of a battery of the terminal, a speed at which the terminal moves, performance of an antenna of the terminal, transmission power of the terminal, a number of usable communication schemes by the terminal, availability of a GPS (Global Positioning System) function of the terminal, and a billing state of the terminal.

5. The wireless communication system according to claim 3, wherein the rule defines that each of the plurality of terminals holds in advance a relationship, and determines the priority based on the held relationship, the relationship being a relationship between the information related to the terminal and the priority.

6. The wireless communication system according to claim 3, wherein
the information related to the terminal includes a plurality of pieces of element information, and
the rule defines that each of the plurality of terminals holds in advance a relationship, calculates a total sum based on the held relationship and determines the priority based on the calculated total sum, the relationship being a relationship between information contents and points for the plurality of pieces of element information, the total sum being a total sum of the points for the plurality of pieces of element information.

7. The wireless communication system according to claim 1, wherein the rule defines that each of the plurality of terminals generates a pseudo random number, and determines the priority based on the generated pseudo random number.

8. The wireless communication system according to claim 1, wherein the rule defines that each of the plurality of terminals executes a process of detecting other terminals, and determines the priority based on a number of the other terminals detected by the process.

9. The wireless communication system according to claim 8, wherein the rule defines that each of the plurality of terminals determines the priority such that, as the number of other terminals detected by the local terminal is larger, the priority is higher.

10. The wireless communication system according to claim 8, wherein the rule defines that each of the plurality of terminals determines the priority such that, as a number of other terminals which have detected the local terminal is larger, the priority is higher.

11. The wireless communication system according to claim 1, wherein the rule defines that the priority is determined based on input information.

12. The wireless communication system according to claim 2, wherein each of the plurality of terminals makes the priority of the local terminal higher as a time from starting the transmission of the certain signal is longer.

13. The wireless communication system according to claim 2, wherein a first terminal of the plurality of terminals stops the transmission of the certain signal at the first terminal in response to reception of the certain signal from a second terminal of the plurality of terminals having a higher priority than a priority of the first terminal.

14. A terminal, wherein the terminal determines a priority according to a certain rule when the certain signal is not received from a wireless base station, the priority being related to transmission of the certain signal at the terminal.

15. A processing method of a terminal, wherein the terminal determines a priority according to a certain rule when a certain signal is not received from a wireless base station, the priority being related to transmission of the certain signal at the terminal.
